(19) United States
(12) Patent Application Publication
(10) Pub. No.: US 2012/0176320 A1
(43) Pub. Date: Jul. 12, 2012

(54) TOUCHSCREEN KEYBOARD DISPLAYS, ALPHANUMERIC INPUT KEYBOARDS AND CONTROL MEANS

(76) Inventor: James W. Burrell, IV, Union, NJ (US)

(21) Appl. No.: 13/342,326

(22) Filed: Jan. 3, 2012

Related U.S. Application Data
(63) Continuation-in-part of application No. 11/083,752, filed on Mar. 18, 2005.
(60) Provisional application No. 61/429,929, filed on Jan. 5, 2011.

(51) Int. Cl. G06F 3/02

(52) U.S. Cl. 345/168

(57) ABSTRACT

The present invention provides a multitude of vertical and horizontal mnemonic user interfaces and displays for entering alphabets, scripts, characters, ideographs, punctuation, symbols, functions, etc. into a device using shiftable and customizable touch screen keyboard displays and user interfaces having a limited amount of touchable sensor zones or keys. The invention also provides user interface enhancements using rearranged placements of alphabetic, numeric, punctuation, symbol and function keys. The touch screen keyboard displays or user interfaces preferably use a ortho-linear grid of horizontal rows and vertical columns of sensors. The preferred mnemonic input labeling embodiment uses a vowel sensor followed by an alphabetical sequence of consonant sensors. The backward, home, cursor left, backspace, space, delete, cursor right, end and forward sensors are preferably on the bottom row. The forward sensor produces the enter function and the backwards sensor produces the shift function. The backward and forward sensors also change display sets.

### RELATED APPLICATION

This application claims priority to and is a continuation in part of U.S. patent application Ser. No. 11/083,752, filed Mar. 18, 2005, titled: “Handheld Wireless Communications Computer and Touch Screen Keyboard” and U.S. Provisional Patent Application Ser. No. 61/429,929, filed Jan. 5, 2011, titled: “Alphanumeric Input Keyboards and Touchscreen Display Keyboards”.

### FIELD OF THE INVENTION

The present invention relates to the arrangement of alphabetic letters on any alphabetic or alphanumeric data input keyboard and the functionality and control means of said keyboard. The present invention also relates to methods and apparatuses for touchscreen display devices for inputting all types of alphanumeric data, scripts, data characters, ideographs, punctuation, symbols, all types of functions, etc. into a computer system or device using customizable, shiftable and refreshable touchscreen keyboard displays, keyboard interfaces and the functionality of the user interface.

### BACKGROUND OF THE INVENTION

The first mechanical writing machines were modified piano keyboards. It was believed that it was possible to type all types of data using individual and simultaneous key activations (chords) on a piano's keyboard. The first patent for a writing machine was issued by the British Patent Office to Henry Mill on Jan. 7, 1714 by Queen Anne of England. The most well known prior art keyboard is the QWERTY keyboard and requires activation of an individual key to produce a data character or function, or the simultaneous activation of two or more keys to produce a secondary data character or function. Another keyboard layout design is the Dvorak keyboard arrangement which was tested to be around twenty percent more efficient for a touch typist to enter data on. The 91 key and the 101 key labeled computer keyboards are the most common type of data entry keyboards. Dual or multiple character labeling of keys requires a key to be simultaneously activated with a shift key, alt key or some other key or keys to produce more than one type of character or function using the same key. Using multiple character labeling on keys makes them difficult to read as the key labeling gets smaller and the key faces get smaller. The keyboard is limited to it's size by the amount of keys required to produce a data set, and the size of each key, which helps to prevent the possibility of more than one key being activated at a time. Obviously, reducing the size of a keyboard, without reducing the number of characters that can be produced, is achieved by decreasing the size of the keys. This method is presently used on cellular and portable devices.

Touchscreen interfaces include resistive touchscreens (which are almost immune to moisture and electromagnetic interference) and capacitive touchscreens (with enhanced transparency and limited multitouch capability, but with EMI and moisture sensitivity).

The resistive touchscreen comprises a flexible outer membrane with an ITO conductive coating (semitransparent indium-tin oxide) on the underside and a transparent glass or substrate coated with conductive material on the topside. Spacer “dots” reinforce an air gap between the membrane and the substrate. Resistive touchscreens can work using a stylus, fingernail, gloved finger, etc. The pressure activated membrane provides an accurate X and Y axis location. A resistive touchscreen requires periodic user recalibration caused by ITO degradation along with membrane expansion and contraction from the changes in ambient temperature and humidity. The light transmission of a resistive touchscreen is 80% or less. The pressure activated resistive touchscreen was not designed for multitouch input because the hardware and software has difficulty recognizing and decoding multitouch actions.

Capacitive touchscreens come in two types, surface capacitance and projected capacitance. Capacitive touchscreens are more durable than the resistive touchscreens because input pressure doesn't deform the conductive materials.

Surface capacitance touchscreens uses a conductive coating applied to one side of a transparent insulator (screen), and when a voltage is applied to the conductive coating, it creates a uniform electrostatic field. The placement of a conductive object (finger, metal stylus, etc.) on the screen stimulates a change in capacitance. Measuring the capacitive change at various locations along the display's edges estimates the X and Y axis location.

Projected capacitance touchscreens provide a more accurate X and Y axis location because a single or dual perpendicular layer XY conductive grid is embedded or etched into the transparent insulator. Projected capacitance touchscreens are either mutual capacitance (the touch input changes the mutual capacitive coupling between sequentially scanned row and column electrodes, with a capacitor at each etched row/column junction) or self capacitive/absolute capacitive (the touch input alters the sensor's parasitic capacitance to the ground). Self capacitance touchscreens provide higher sensed signal strength but cannot sense more than one simultaneous input (two fingers on one grid line are sensed as one activated grid line) and produce wrong location “ghosting” errors. Mutual capacitance touchscreens are the best technology for two finger multitouch interfaces. This capacitive touchscreen gives users the ability to zoom in or out using a browser screen, map, image or video by moving two simultaneously applied finger tips toward or away from each other. The mutual capacitance system's touchscreen controller individually senses each XY intersection point. The light transmission of a capacitive touchscreen is often 90% or more.

Other touch technologies include SAW (surface acoustic wave), infrared, strain gauge, optical imaging, dispersive signal, and acoustic pulse recognition. SAW technology uses ultrasonic waves that pass over the touchscreen surface. When a user touches the surface, it absorbs a portion of the wave which registers the position of the touch. An infrared touchscreen uses an array of infrared XY LEDs and photodetector pairs around the edges of the touchscreen to detect obstruction of the LED beams. In strain gauge/force panel technology, the touchscreen is spring mounted on four corners, and strain gauges determine deflection when a user touches the screen. In optical imaging, two or more image sensors are positioned on the edges of the touchscreen. Infrared lighting is projected across the surface of the touchscreen. A touch produces a shadow which is triangulated to determine the touch location or size of the touching object. Dispersive signal technology uses sensors to detect the mechanical energy in the glass that a touch produces. Complex algorithms interpret the touch location information and provide the actual location of the touch. Acoustic pulse recognition uses piezoelectric transducers around the screen to turn the mechanical energy of a touch into an electronic signal. The screen hardware uses an algorithm to determine the location of the touch using the transducer signals. There are other advances in touchscreen technologies and the multitouch technology.

It is well known in the prior art, that inputting alphanumeric data and other types of data requires activation of a key or activation of multiple keys to produce a data character or function. Applicant's prior art U.S. Pat. No. 5,993,089 discloses a method of chordic multitouch typing using an eight key chordic typing method which can be used as a method of finger braille communication by the deaf-blind and as an alternative eight dot braille arrangement. Texting on a phone uses twelve keys to produce alphanumeric data. Compared to all other prior art, the fastest and most efficient ways of using a phone keypad to produce data (texting) are found in the Applicant's U.S. Pat. No. 6,043,761, U.S. Pat. No. 6,184,803, U.S. Pat. No. 6,232,892, U.S. patent application Ser. No. 09/910,323, entitled “METHOD OF USING TWELVE SENSORS”, and other future patent applications by the Applicant cover over fourteen methods of data entry using eight, nine or twelve sensors to enter data which are faster and more efficient than all the prior art.

In touch typing, when the fingers are on home row and you move up, the top row is misaligned. When the fingers are on home row and you move down, the fingers end up between the keys on the bottom row. The staggered nature of the rows of keys on typewriters and computer keyboards is unergonomic and makes visual mnemonic memorization of the QWERTY keyboard arrangement difficult. An “ortho-linear” keyboard, also known as a “matrix” or “grid” keyboard, solves these problems.

Keys having an 0.75 inch size is the optimum size for fast key entry by the average size hand. Keyboards with the 0.75 inch key size are called “full-sized keyboards”. Touchscreen devices use much smaller size keys (touch sensor zones) and do not take into account that when a fingertip touches something it produces a wider fingertip print compared to the vertical height of the touch.

As electronic devices get smaller and smaller, other methods and systems of data entry and keyboards are needed to provide data input for all languages used throughout the world. The present invention and Applicant's prior art inventions, all address the above identified problems by providing multiple embodiments which independently or all together eliminate these problems.

### SUMMARY OF THE INVENTION

Accordingly, the present invention comprises methods and apparatuses for providing a mnemonic vowel, QWERTY or other keyboard arrangement, two screen toggling sensors/keys (forward and backward) as a control means and for changing the refreshable display to at least two or more different keyboard screen displays. The keyboard preferably includes a backward, home, cursor left, backspace, space, delete, cursor right, end and forward sensors on the bottom row. Computer keyboards/keypads use the forward sensor as the enter key, activation of the backward sensor one time produces the shift function, two times produces the caps lock function, and three times produces a secondary character lock function or other function, where activation of any sensor other than the backward sensor produces the secondary character or function for that sensor, and successive secondary activation of the backward sensor returns the device to the normal/standard data entry mode or the previous mode.

It is an object of the present invention to provide a touchscreen interface for the input of all types of alphabets, scripts, characters, ideographs, punctuation, symbols and functions requiring a separate input key or sensor for each character and function. Input keys are pre-defined areas on a touchscreen interface which are labeled with a pre-defined character or function which can be modified by changing the location of a data character or function, or by activating the forward or backward sensor.

Some of the applications of said touchscreen devices are for small input devices including touchscreen phones, touchscreen PDAs, touchscreen displays, touchscreen watches or any type of touchscreen data entry device or keyboard.

It is another object of the present invention to provide a device with a touchscreen keyboard display which changes character mappings and displays alternative characters and functions by activating a first sensor or a second sensor (forward and backward) to shift into secondary or alternative keyboard displays.

It is still another object of the present invention to provide a keyboard for entering alphanumeric data wherein alphanumeric characters, punctuation, symbols and function keys are located on an “ortho-linear” keyboard also known as a “matrix” or “grid” keyboard arrangement.

It is yet another object of the present invention to provide keyboard with a backspace key located to the left of a space bar key and a delete key located to the left of a space bar key.

It is a further object of the present invention to provide a keyboard for entering alphanumeric data wherein each vowel sensor is followed by an alphabetical sequence of consonant sensors.

It is yet a further object of the present invention to provide a keyboard and touch sensor display disclosed in the aforementioned objects and features for entering all types of alphabets, scripts, characters, ideographs, punctuation, symbols and functions for all languages used throughout the known world. This would be an extremely lengthy patent application if Applicant included all the preferred embodiments of the present invention for all of the languages used throughout the known world.

These and other objects, features and advantages of the present invention are provided within this patent application and will be better understood in connection with the following drawings and descriptions of the preferred embodiments. A multitude of modifications and enhancements can be made to the disclosed methods and apparatuses without departing from the spirit and scope of the invention as a whole.

To provide a further understanding of the invention, the foregoing general description, the following detailed description and the accompanying drawings are exemplary (included only for illustration of the invention), and are intended to provide further explanation of the multiple embodiments of the present invention as claimed.

### BRIEF DESCRIPTION OF THE DRAWINGS

The accompanying drawings provide a further understanding of the invention, and are incorporated in and constitute a part of this specification. The drawings illustrate preferred embodiments of the invention, and together with the description, serve to explain the principles of the invention. A brief introduction of the drawings is as follows:

FIG. 1 is a top view of Applicant's improved prior art alphanumeric telephone keypad multi-tap texting arrangement for reducing the amount of keystrokes required for producing data (texting) using twelve sensors, which is an improvement of Applicant's issued prior art patents.

FIG. 2 is a top view of Applicant's improved prior art alphanumeric telephone keypad multi-tap and directional texting arrangement for reducing the amount of keystrokes required for producing data using nine sensors.

FIG. 3 is a top view of Applicant's improved nine sensor prior art alphanumeric telephone keypad multi-tap and directional texting arrangement, shown in FIG. 2, reduced in size to the lower left hand corner of the display area.

FIG. 4 is a top view of Applicant's improved nine sensor prior art alphanumeric telephone keypad multi-tap and directional texting arrangement, shown in FIG. 2, reduced in size to the lower right hand corner of the display area.

FIG. 5 is a top view of one example of a menu and function display of a touchscreen interface device.

FIG. 6 is a top view of a thirty sensor vertical alphabetic keyboard with five columns and six rows on the bottom of a browser display.

FIG. 7 is a top view of a thirty sensor horizontal alphabetic keyboard with six columns and five rows on the bottom of a browser display.

FIG. 8 is a top view of a first vertical screen thirty sensor vertical alphabetic keyboard display with five columns and six rows.

FIG. 9 is a top view of a second vertical screen thirty sensor vertical alphabetic keyboard display with five columns and six rows.

FIG. 10 is a top view of a third vertical screen thirty sensor vertical alphabetic keyboard display with five columns and six rows.

FIG. 11 is a top view of a first vertical screen thirty-five sensor vertical alphabetic keyboard display with five columns and seven rows.

FIG. 12 is a top view of a second vertical screen thirty-five sensor vertical alphabetic keyboard display with five columns and seven rows.

FIG. 13 is a top view of a third vertical screen thirty-five sensor vertical alphabetic keyboard display with five columns and seven rows.

FIG. 14 is a top view of a first vertical screen thirty sensor horizontal alphabetic keyboard display with six columns and five rows.

FIG. 15 is a top view of a second vertical screen thirty sensor horizontal alphabetic keyboard display with six columns and five rows.

FIG. 16 is a top view of a third vertical screen thirty sensor horizontal alphabetic keyboard display with six columns and five rows.

FIG. 17 is a top view of a first vertical screen thirty-six sensor horizontal alphabetic keyboard display with six columns and six rows.

FIG. 18 is a top view of a second vertical screen thirty-six sensor horizontal alphabetic keyboard display with six columns and six rows.

FIG. 19 is a top view of a third vertical screen thirty-six sensor horizontal alphabetic keyboard display with six columns and six rows.

FIG. 20 is a top view of a first vertical screen sixty sensor vertical alphabetic keyboard display with six columns and ten rows.

FIG. 21 is a top view of a second vertical screen sixty sensor vertical alphabetic keyboard display with six columns and ten rows.

FIG. 22 is a top view of a third vertical screen sixty sensor keyboard vertical alphabetic display with six columns and ten rows.

FIG. 23 is a top view of a first horizontal screen thirty-six sensor horizontal alphabetic keyboard display with nine columns and four rows.

FIG. 24 is a top view of a second horizontal screen thirty-six sensor horizontal alphabetic keyboard display with nine columns and four rows.

FIG. 25 is a top view of a third horizontal screen thirty-six sensor horizontal alphabetic keyboard display with nine columns and four rows.

FIG. 26 is a top view of a first horizontal screen forty sensor first horizontal alphabetic keyboard display with ten columns and four rows.

FIG. 27 is a top view of a second horizontal screen forty sensor first horizontal alphabetic keyboard display with ten columns and four rows.

FIG. 28 is a top view of a third horizontal screen forty sensor first horizontal alphabetic keyboard display with ten columns and four rows.

FIG. 29 is a top view of a first horizontal screen forty sensor second horizontal alphabetic keyboard display with ten columns and four rows.

FIG. 30 is a top view of a second horizontal screen forty sensor second horizontal alphabetic keyboard display with ten columns and four rows.

FIG. 31 is a top view of a third horizontal screen forty sensor second horizontal alphabetic keyboard display with ten columns and four rows.

FIG. 32 is a top view of a first horizontal screen fifty sensor horizontal alphabetic keyboard display with ten columns and five rows.

FIG. 33 is a top view of a second horizontal screen fifty sensor horizontal alphabetic keyboard display with ten columns and five rows.

FIG. 34 is a top view of a third horizontal screen fifty sensor horizontal alphabetic keyboard display with ten columns and five rows.

FIG. 35 is a top view of a first horizontal screen forty-two sensor/forty-eight sensor zone vertical alphabetic keyboard display with eight columns and six rows.

FIG. 36 is a top view of a second horizontal screen forty-two sensor/forty-eight sensor zone vertical alphabetic keyboard display with eight columns and six rows.

FIG. 37 is a top view of a first horizontal screen thirty sensor QWERTY keyboard display with ten columns and three rows.

FIG. 38 is a top view of a second horizontal screen thirty sensor QWERTY keyboard display with ten columns and three rows.

FIG. 39 is a top view of a third horizontal screen thirty sensor QWERTY keyboard display with ten columns and three rows.

FIG. 40 is a top view of a first horizontal screen thirty-three sensor QWERTY keyboard display with eleven columns and three rows.

FIG. 41 is a top view of a second horizontal screen thirty-three sensor QWERTY keyboard display with eleven columns and three rows.

FIG. 42 is a top view of a third horizontal screen thirty-three sensor QWERTY keyboard display with eleven columns and three rows.

FIG. 43 is a top view of a first horizontal screen fifty sensor first QWERTY keyboard display with ten columns and five rows.

FIG. 44 is a top view of a second horizontal screen fifty sensor first QWERTY keyboard display with ten columns and five rows.

FIG. 45 is a top view of a third horizontal screen fifty sensor first QWERTY keyboard display with ten columns and five rows.

FIG. 46 is a top view of a first horizontal screen fifty sensor second QWERTY keyboard display with ten columns and five rows.

FIG. 47 is a top view of a second horizontal screen fifty sensor second QWERTY keyboard display with ten columns and five rows.

FIG. 48 is a top view of a third horizontal screen fifty sensor second QWERTY keyboard display with ten columns and five rows.

FIG. 49 is a top view of a first horizontal screen thirty sensor Dvorak keyboard display with ten columns and three rows.

FIG. 50 is a top view of a first horizontal screen thirty sensor QWERTZ keyboard display with ten columns and three rows.

FIG. 51 is a top view of a first horizontal screen thirty sensor AZERTY keyboard display with ten columns and three rows.

FIG. 52 is a top view of a first horizontal screen thirty sensor Alphabetic keyboard display with ten columns and three rows.

FIG. 53 is a top view of a first horizontal screen thirty sensor Colemak keyboard display with ten columns and three rows.

FIG. 54 is a top view of a first horizontal screen thirty sensor Workman keyboard display with ten columns and three rows.

FIG. 55 is a top view of a first horizontal screen forty sensor QWERTY keyboard display with ten columns and four rows.

FIG. 56 is a top view of a second horizontal screen forty sensor QWERTY keyboard display with ten columns and four rows.

FIG. 57 is a top view of a third horizontal screen forty sensor QWERTY keyboard display with ten columns and four rows.

FIG. 58 is a top view of a horizontal sixty sensor multi-labeled key horizontal alphabetic keypad or display with ten columns and six rows.

FIG. 59 is a top view of a horizontal fifty sensor multi-labeled key horizontal alphabetic keypad or display with ten columns and five rows.

FIG. 60 is a top view of a horizontal forty sensor multi-labeled key horizontal alphabetic keypad or display with ten columns and four rows.

FIG. 61 is a top view of a horizontal sixty sensor multi-labeled key QWERTY keypad or display with ten columns and six rows.

FIG. 62 is a top view of a horizontal fifty sensor multi-labeled key QWERTY keypad or display with ten columns and five rows.

FIG. 63 is a top view of a horizontal forty sensor multi-labeled key QWERTY keypad or display with ten columns and four rows.

### LIST OF REFERENCE SENSOR LABELING

A-Z or a-z are the vowel and consonant labeled sensors/keys.
[1]-[9] and [0] are the number labeled sensors/keys.
Punctuation marks are the punctuation labeled sensors/keys.
Symbols are the symbol labeled ([@], [#], [$], [&], [*], [˜], [/], [\], etc.) sensors/keys.
[+], [−], [×], [÷], [=], [²] and [%] are the mathematical function labeled sensors/keys.
Functions are the function labeled ([Home], [BkSp], [Sp], [Del], [End], [PgUp], [PgDn], [F1]-[F10], etc.) sensors/keys. [symbol]
and [symbol] are the backward [ [symbol] ] (previous) or shift function and forward [ [symbol] ] (next) or enter function labeled function sensors/keys. [symbol]
is the Enter labeled sensor/key [ [symbol] ].
↑ and ↓ are the cursor up [↑] sensor/key and cursor down [↓] sensor/key.
← and → are the cursor left [←] sensor/key and cursor right [→] sensor/key.
∥← or ← and → or →| are the back tab function and tab function on a labeled or unlabeled sensor/key.

### DETAILED DESCRIPTION OF THE PREFERRED EMBODIMENTS

Wherever possible in the following description, like reference labeling will refer to like elements and parts, unless otherwise illustrated. It will be apparent to one skilled in the art that well known features have not been described in detail to avoid obscuring the multiple embodiments of the invention. Additional objects of the present invention will become apparent as the description proceeds.

In order to more fully understand the invention, during the course of this description, the touchscreen keyboard and keyboard inventions with preferred user interface embodiments and preferred sensor/key arrangements will be labeled and explained to easily identify like elements according to the different figures which illustrate the invention. All of the preferred embodiments preferably use an “ortho-linear” keyboard, also known as a “matrix” or “grid” keyboard arrangement, for ease of use and mnemonic implementation.

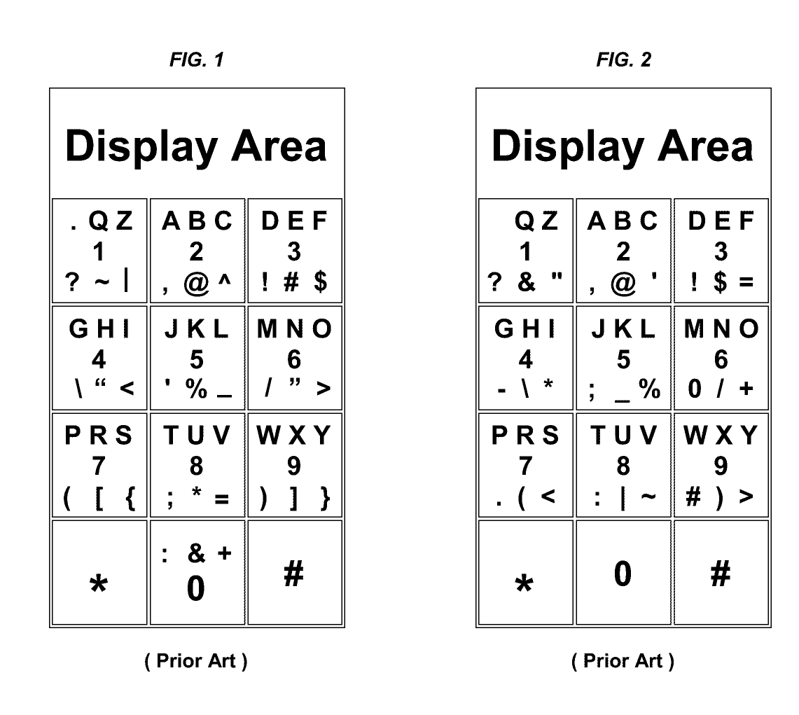

FIG. 1 is a top view of Applicant's improved prior art alphanumeric telephone keypad arrangement using multi-tap or simultaneous two key activation texting for reducing the amount of keystrokes required for producing data using twelve sensors, which is an improvement over Applicant's previous U.S. Pat. No. 6,184,803, filed Jul. 22, 1997, titled: “Nine Key Alphanumeric Binary Keyboard Combined with a Three Key Keyboard Control Keyboard and Combinational Control Means”, U.S. Pat. No. 6,232,892, filed Jul. 20, 1998, titled: “Method of Using a Nine Key Alphanumeric Binary Keyboard Combined with a Three Key Keyboard Control Keyboard”, and U.S. Pat. No. 6,043,761, filed Jul. 24, 1998, titled: “Method of Using a Nine Key Alphanumeric Binary Keyboard Combined with a Three Key Keyboard Control Keyboard”. The left row of sensors; [1], [4], [7] and [*] can be used as multitouch sensors by the left thumb, index, middle and ring fingers; and the right row of sensors; [3], [6], [9] and [#] can be used as multitouch sensors by the right thumb, index, middle and ring fingers, allowing eight finger multitouch chordic typing on a touchscreen display or keypad. Placing the fingers over the multitouch user interface and ergonomically touching the multitouch user interface with the fingertips of the thumb, index, middle and ring fingers and then removing the eight fingertips from the multitouch user interface surface, also sets the touch zone sensor locations as previously and partially shown in FIGS. 1A, 1E, 1C and 1F of Applicant's U.S. Pat. No. 5,993,089, filed Feb. 3, 1997 (originally filed Feb. 3, 1992), titled: “8-bit Binary Code for Use as an 8-dot Braille Arrangement and Data Entry System and Method for 8-key Chordic Binary Keyboards”.

FIG. 2 is a top view of Applicant's improved prior art alphanumeric telephone keypad multi-tap or nine directional texting arrangement for reducing the amount of keystrokes required for producing data using nine sensors.

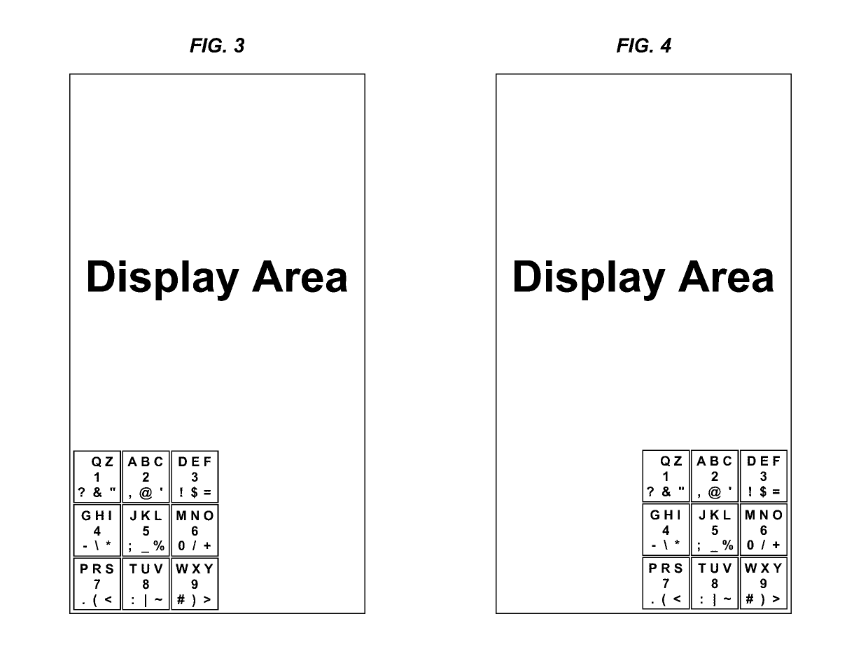

FIG. 3 is a top view of Applicant's improved nine sensor prior art alphanumeric telephone keypad multi-tap and directional texting arrangement, shown in FIG. 2, reduced in size to the lower left hand corner of the display area by touching the [3] sensor and dragging the finger tip towards the [*] asterisk sensor on enabled devices or by having a device preprogrammed for nine sensor input.

FIG. 4 is a top view of Applicant's improved nine sensor prior art alphanumeric telephone keypad multi-tap and directional texting arrangement, shown in FIG. 2, reduced in size to the lower right hand corner of the display area by touching the [1] sensor and dragging the finger tip towards the [#] pound sensor on enabled devices or by having a device preprogrammed for nine sensor input. In FIGS. 2, 3 and 4, nine sensor multi-tapping or directional swiping/moving a sensor in eight directions along with tapping/pressing a sensor downward produces data.

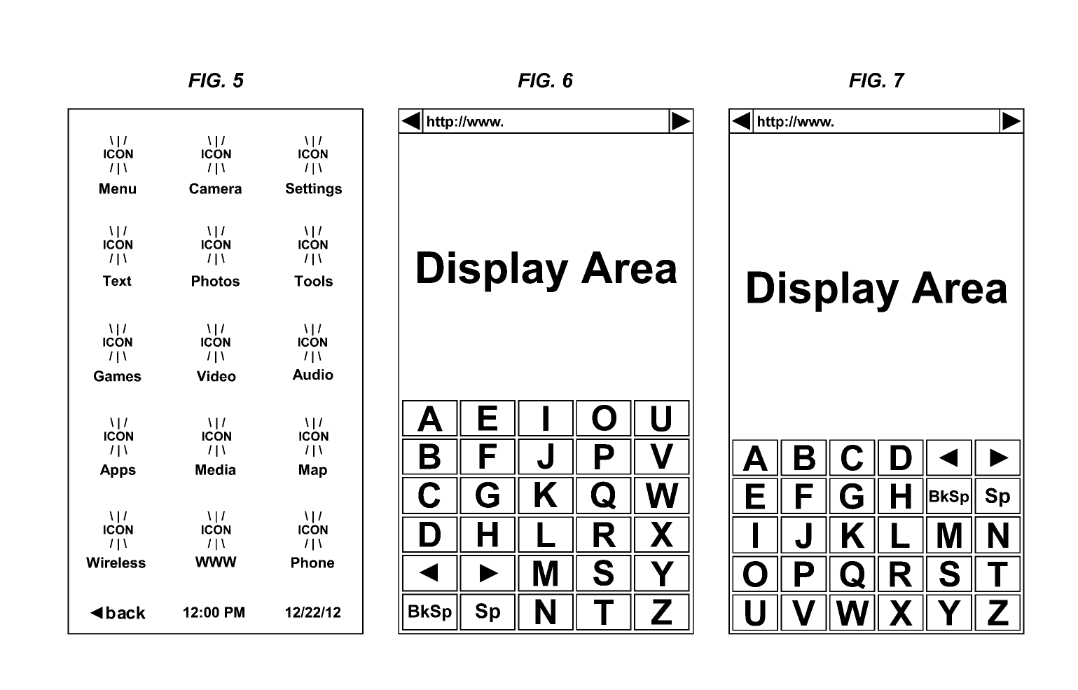

FIG. 5 is a top view of one example of a menu and function display of a touchscreen interface device. Activating the settings sensor allows the user to set the preferred keyboard used in a browser shown in FIGS. 6-7, accessed when activating the WWW sensor, or any of the keyboards partially shown or desired in FIGS. 8-63.

FIG. 6 is a top view of a thirty sensor vertical alphabetic keyboard with five columns and six rows wherein the top horizontal row of vowel sensors are vertically followed by an alphabetical sequence of consonant sensors, along with a space, backspace, and forward and backward keys or sensors positioned on the bottom of a browser display.

FIG. 7 is a top view of a thirty sensor horizontal alphabetic keyboard with six columns and five rows wherein the left vertical row of vowel sensors are horizontally followed by an alphabetical sequence of consonant sensors, along with a space, backspace, and forward and backward keys or sensors positioned on the bottom of a browser display.

FIG. 8 is a top view of a first vertical screen thirty sensor vertical alphabetic keyboard display with five columns and six rows wherein the top horizontal row of capital vowel sensors are vertically followed by an alphabetical sequence of capital consonant sensors and comprises the space, backspace, forward and backward sensors. Activation of the forward sensor changes the screen to a second keyboard display and activation of the backward sensor changes the screen to a third keyboard display.

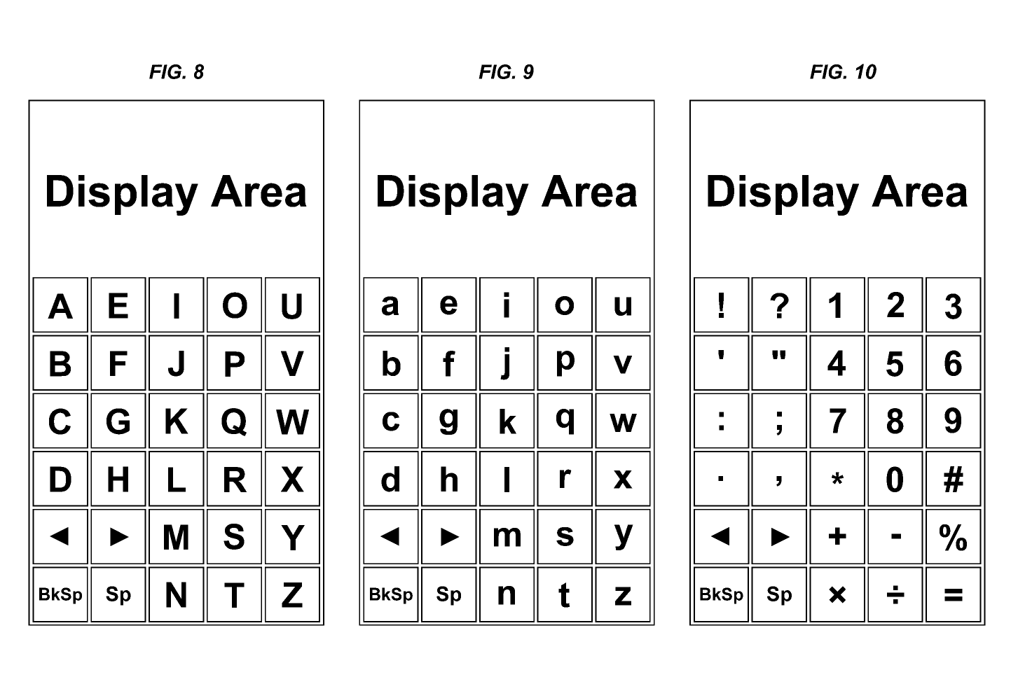

FIG. 9 is a top view of a second vertical screen thirty sensor vertical alphabetic keyboard display with five columns and six rows wherein the top horizontal row of vowel sensors are vertically followed by an alphabetical sequence of consonant sensors and comprises the space, backspace, forward and backward sensors. Activation of the forward sensor changes the screen to a third keyboard display and activation of the backward sensor changes the screen to a first keyboard display.

FIG. 10 is a top view of a third vertical screen thirty sensor vertical alphabetic keyboard display with five columns and six rows comprising punctuation sensors, a numeric phone keypad sensor arrangement and mathematical function sensors and comprises the space, backspace, forward and backward sensors. Activation of the forward sensor changes the screen to a first keyboard display and activation of the backward sensor changes the screen to a second keyboard display. A fourth vertical screen thirty sensor vertical alphabetic keyboard display can be added to increase the data characters and functions.

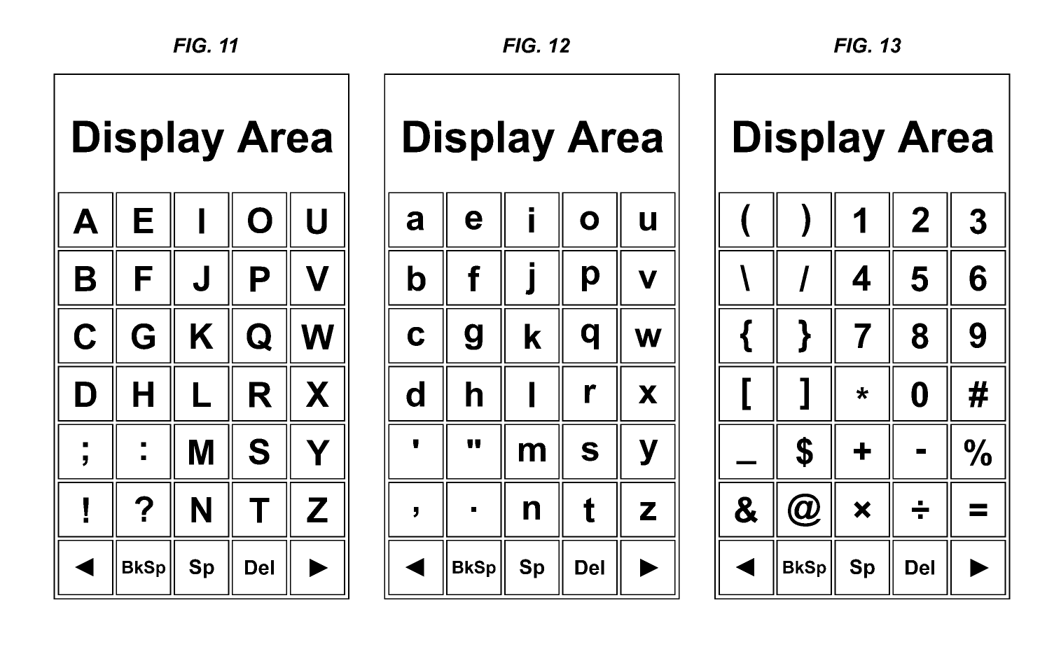

FIG. 11 is a top view of a first vertical screen thirty-five sensor vertical alphabetic keyboard display with five columns and seven rows wherein the top horizontal row of capital vowel sensors are vertically followed by an alphabetical sequence of capital consonant sensors and comprises punctuation sensors, and the backward, backspace, space, delete and forward sensors on the bottom row. Activation of the forward sensor changes the screen to a second keyboard display and activation of the backward sensor changes the screen to a third keyboard display.

FIG. 12 is a top view of a second vertical screen thirty-five sensor vertical alphabetic keyboard display with five columns and seven rows wherein the top horizontal row of vowel sensors are vertically followed by an alphabetical sequence of consonant sensors and comprises punctuation sensors, and the backward, backspace, space, delete and forward sensors on the bottom row. Activation of the forward sensor changes the screen to a third keyboard display and activation of the backward sensor changes the screen to a first keyboard display.

FIG. 13 is a top view of a third vertical screen thirty-five sensor vertical alphabetic keyboard display with five columns and seven rows comprising containment and symbol sensors, a numeric phone keypad sensor arrangement, mathematical function sensors, and comprises the backward, backspace, space, delete and forward sensors on the bottom row. Activation of the forward sensor changes the screen to a first keyboard display and activation of the backward sensor changes the screen to a second keyboard display. A fourth vertical screen thirty-five sensor vertical alphabetic keyboard display can be added to increase the data characters and functions.

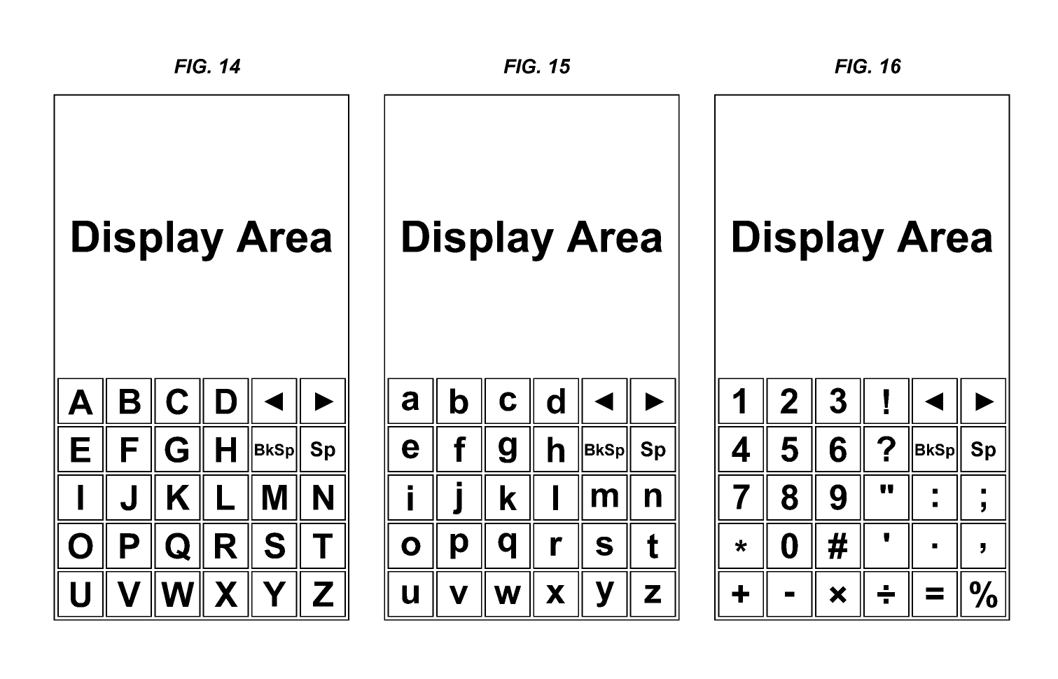

FIG. 14 is a top view of a first vertical screen thirty sensor horizontal alphabetic keyboard display with six columns and five rows wherein the left vertical column of capital vowel sensors are horizontally followed by an alphabetical sequence of capital consonant sensors and comprises the space, backspace, forward and backward sensors. Activation of the forward sensor changes the screen to a second keyboard display and activation of the backward sensor changes the screen to a third keyboard display.

FIG. 15 is a top view of a second vertical screen thirty sensor horizontal alphabetic keyboard display with six columns and five rows wherein the left vertical column of vowel sensors are horizontally followed by an alphabetical sequence of consonant sensors and comprises the space, backspace, forward and backward sensors. Activation of the forward sensor changes the screen to a third keyboard display and activation of the backward sensor changes the screen to a first keyboard display.

FIG. 16 is a top view of a third vertical screen thirty sensor horizontal alphabetic keyboard display with six columns and five rows comprising punctuation sensors, a numeric phone keypad sensor arrangement and mathematical function sensors and comprises the space, backspace, forward and backward sensors. Activation of the forward sensor changes the screen to a first keyboard display and activation of the backward sensor changes the screen to a second keyboard display. A fourth vertical screen thirty sensor horizontal alphabetic keyboard display can be added to increase the data characters and functions.

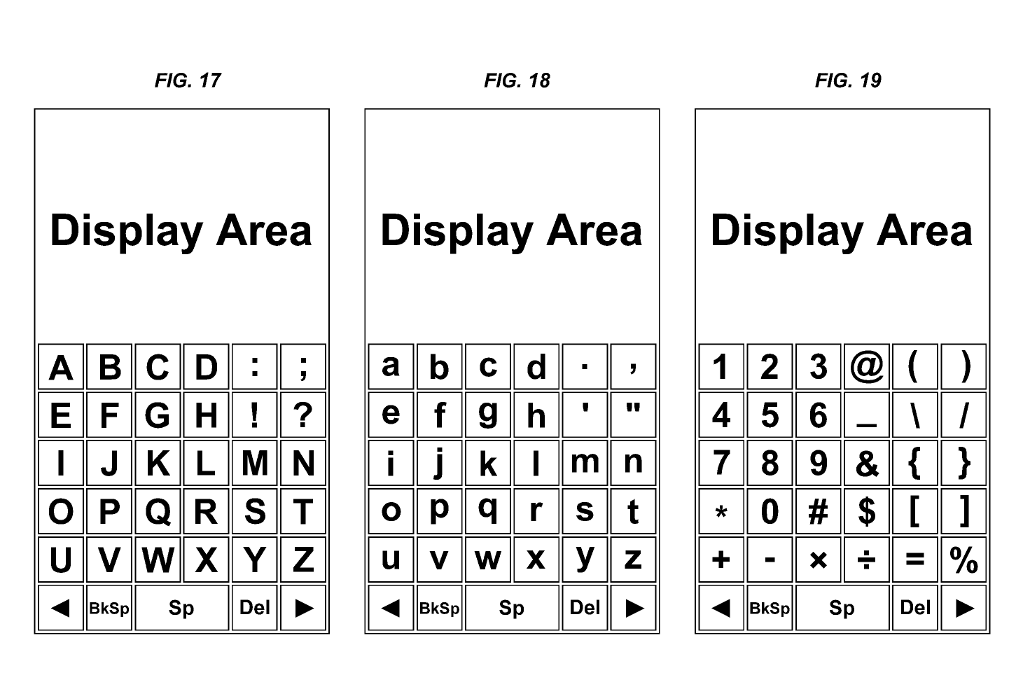

FIG. 17 is a top view of a first vertical screen thirty-six sensor horizontal alphabetic keyboard display with six columns and six rows wherein the left vertical column of capital vowel sensors are horizontally followed by an alphabetical sequence of capital consonant sensors and comprises punctuation sensors, the backward, backspace, space, delete and forward sensors are on the bottom row. Activation of the forward sensor changes the screen to a second keyboard display and activation of the backward sensor changes the screen to a third keyboard display.

FIG. 18 is a top view of a second vertical screen thirty-six sensor horizontal alphabetic keyboard display with six columns and six rows wherein the left vertical column of vowel sensors are horizontally followed by an alphabetical sequence of consonant sensors and comprises punctuation sensors, the backward, backspace, space, delete and forward sensors are on the bottom row. Activation of the forward sensor changes the screen to a third keyboard display and activation of the backward sensor changes the screen to a first keyboard display.

FIG. 19 is a top view of a third vertical screen thirty-six sensor horizontal alphabetic keyboard display with six columns and six rows comprising containment and symbol sensors, a numeric phone keypad sensor arrangement, mathematical function sensors, and comprises the backward, backspace, space, delete and forward sensors on the bottom row. Activation of the forward sensor changes the screen to a first keyboard display and activation of the backward sensor changes the screen to a second keyboard display. A fourth vertical screen thirty-six sensor horizontal alphabetic keyboard display can be added to increase the data characters and functions.

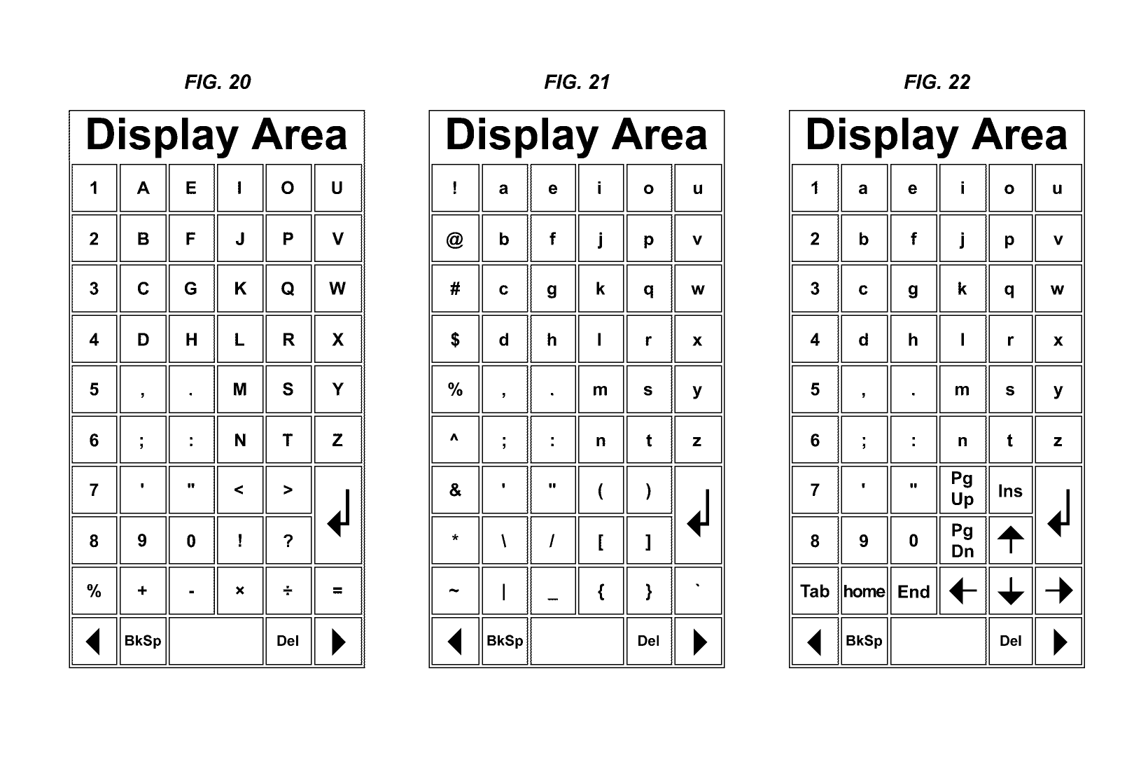

FIG. 20 is a top view of a first vertical screen sixty sensor vertical alphabetic keyboard display with six columns and ten rows wherein the top horizontal row of capital vowel sensors are vertically followed by an alphabetical sequence of capital consonant sensors and comprises punctuation sensors, number sensors, mathematical function sensors, the enter sensor, and the backward, backspace, space, delete and forward sensors are on the bottom row. Activation of the forward sensor changes the screen to a second keyboard display and activation of the backward sensor changes the screen to a third keyboard display.

FIG. 21 is a top view of a second vertical screen sixty sensor vertical alphabetic keyboard display with six columns and ten rows wherein the top horizontal row of vowel sensors are vertically followed by an alphabetical sequence of consonant sensors and comprises punctuation sensors, symbol sensors, containment sensors, the enter sensor, and the backward, backspace, space, delete and forward sensors are on the bottom row. Activation of the forward sensor changes the screen to a third keyboard display and activation of the backward sensor changes the screen to a first keyboard display.

FIG. 22 is a top view of a third vertical screen sixty sensor keyboard vertical alphabetic display with six columns and ten rows wherein the top horizontal row of vowel sensors are vertically followed by an alphabetical sequence of consonant sensors and comprises punctuation sensors, function sensors, cursor movement sensors, the enter sensor, and the backward, backspace, space, delete and forward sensors are on the bottom row. Activation of the forward sensor changes the screen to a first keyboard display and activation of the backward sensor changes the screen to a second keyboard display. A fourth vertical screen sixty sensor vertical alphabetic keyboard display can be added to increase the data characters and functions.

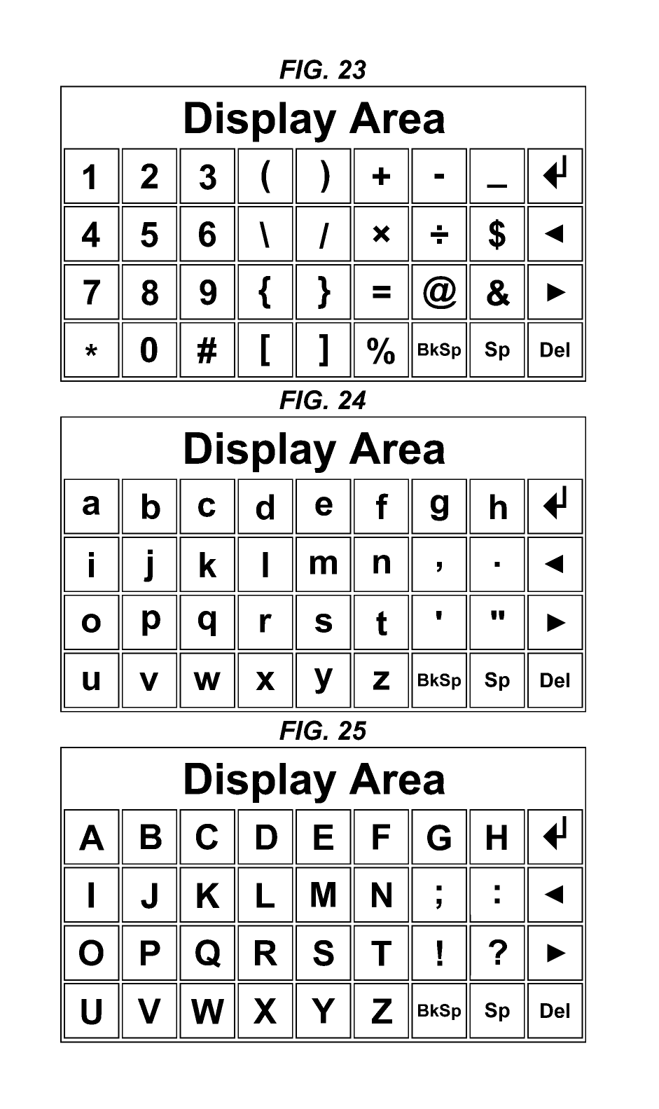

FIG. 23 is a top view of a first horizontal screen thirty-six sensor horizontal alphabetic keyboard display with nine columns and four rows wherein the left vertical column of capital vowel sensors are horizontally followed by an alphabetical sequence of capital consonant sensors and comprises punctuation sensors, the enter sensor, backward and forward sensors, and the backspace, space and delete sensors are on the bottom row. Activation of the forward sensor changes the screen to a second keyboard display and activation of the backward sensor changes the screen to a third keyboard display.

FIG. 24 is a top view of a second horizontal screen thirty-six sensor horizontal alphabetic keyboard display with nine columns and four rows wherein the left vertical column of vowel sensors are horizontally followed by an alphabetical sequence of consonant sensors and comprises punctuation sensors, the enter sensor, backward and forward sensors, and the backspace, space and delete sensors are on the bottom row. Activation of the forward sensor changes the screen to a third keyboard display and activation of the backward sensor changes the screen to a first keyboard display.

FIG. 25 is a top view of a third horizontal screen thirty-six sensor horizontal alphabetic keyboard display with nine columns and four rows comprising containment sensors, a numeric phone keypad sensor arrangement, mathematical function sensors, symbol sensors, the enter sensor, backward and forward sensors, and the backspace, space and delete sensors are on the bottom row. Activation of the forward sensor changes the screen to a first keyboard display and activation of the backward sensor changes the screen to a second keyboard display. A fourth horizontal screen thirty-six sensor horizontal alphabetic keyboard display can be added to increase the data characters and functions.

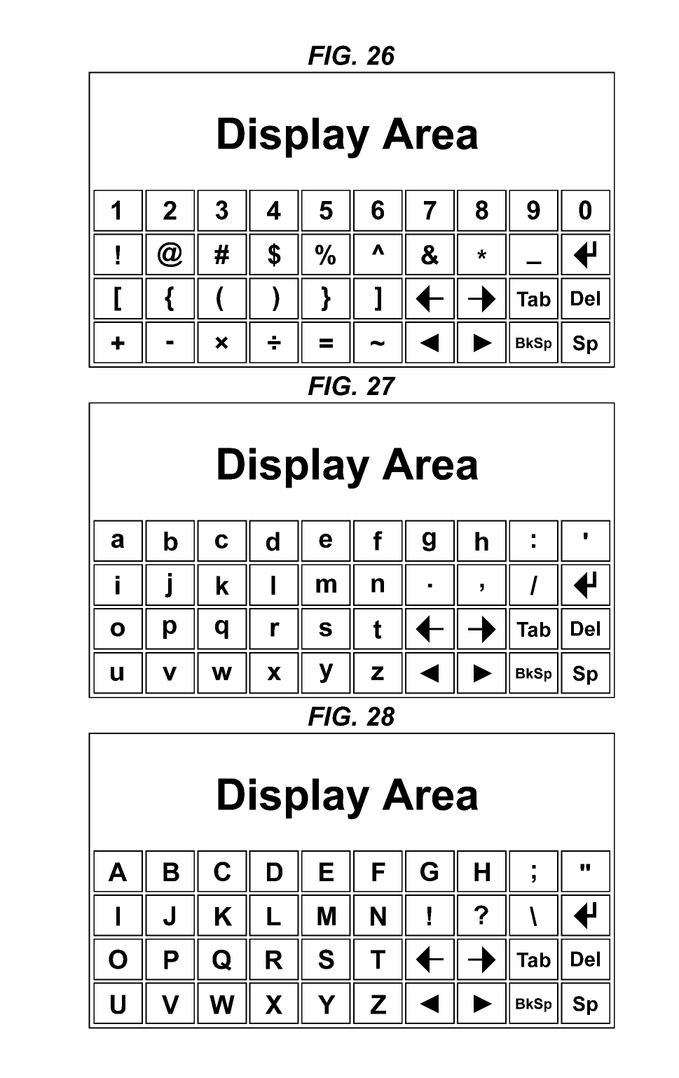

FIG. 26 is a top view of a first horizontal screen forty sensor horizontal alphabetic keyboard display with ten columns and four rows wherein the left vertical column of capital vowel sensors are horizontally followed by an alphabetical sequence of capital consonant sensors and comprises punctuation sensors, the enter sensor, tab sensor, cursor left and right sensors, and the backward, forward, backspace and space sensors are on the bottom row. Activation of the forward sensor changes the screen to a second keyboard display and activation of the backward sensor changes the screen to a third keyboard display.

FIG. 27 is a top view of a second horizontal screen forty sensor horizontal alphabetic keyboard display with ten columns and four rows wherein the left vertical column of vowel sensors are horizontally followed by an alphabetical sequence of consonant sensors and comprises punctuation sensors, the enter sensor, tab sensor, cursor left and right sensors, and the backward, forward, backspace and space sensors are on the bottom row. Activation of the forward sensor changes the screen to a third keyboard display and activation of the backward sensor changes the screen to a first keyboard display.

FIG. 28 is a top view of a third horizontal screen forty sensor horizontal alphabetic keyboard display with ten columns and four rows comprising containment sensors, punctuation, a numeric phone keypad sensor arrangement, mathematical function sensors, symbol sensors, the enter sensor, tab sensor, cursor left and right sensors, and the backward, forward, backspace and space sensors are on the bottom row. Activation of the forward sensor changes the screen to a first keyboard display and activation of the backward sensor changes the screen to a second keyboard display. A fourth horizontal screen forty sensor horizontal alphabetic keyboard display can be added to increase the data characters and functions.

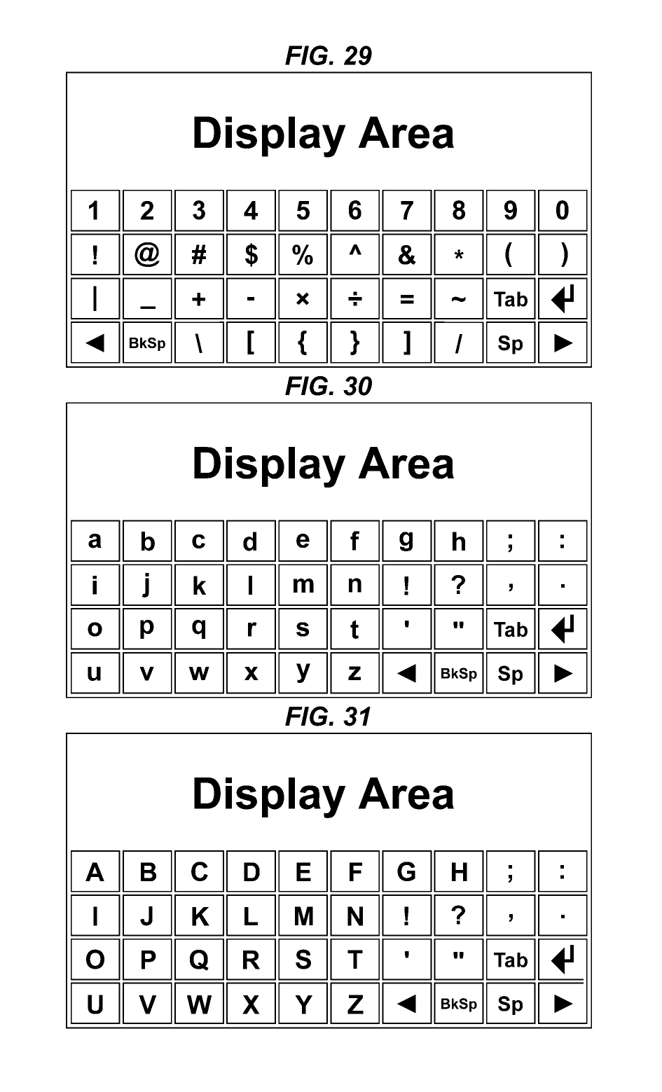

FIG. 29 is a top view of a first horizontal screen forty sensor horizontal alphabetic keyboard display with ten columns and four rows wherein the left vertical column of capital vowel sensors are horizontally followed by an alphabetical sequence of capital consonant sensors and comprises punctuation sensors, the enter sensor, tab sensor, and the backward, backspace, space and forward sensors are on the bottom row. Activation of the forward sensor changes the screen to a second keyboard display and activation of the backward sensor changes the screen to a third keyboard display.

FIG. 30 is a top view of a second horizontal screen forty sensor horizontal alphabetic keyboard display with ten columns and four rows wherein the left vertical column of vowel sensors are horizontally followed by an alphabetical sequence of consonant sensors and comprises punctuation sensors, the enter sensor, tab sensor, and the backward, backspace, space and forward sensors are on the bottom row. Activation of the forward sensor changes the screen to a third keyboard display and activation of the backward sensor changes the screen to a first keyboard display.

FIG. 31 is a top view of a third horizontal screen forty sensor horizontal alphabetic keyboard display with ten columns and four rows comprising containment sensors, punctuation, a numeric phone keypad sensor arrangement, mathematical function sensors, symbol sensors, the enter sensor, tab sensor, and the backward, backspace, space and forward sensors are on the bottom row. Activation of the forward sensor changes the screen to a first keyboard display and activation of the backward sensor changes the screen to a second keyboard display. A fourth horizontal screen forty sensor horizontal alphabetic keyboard display can be added to increase the data characters and functions.

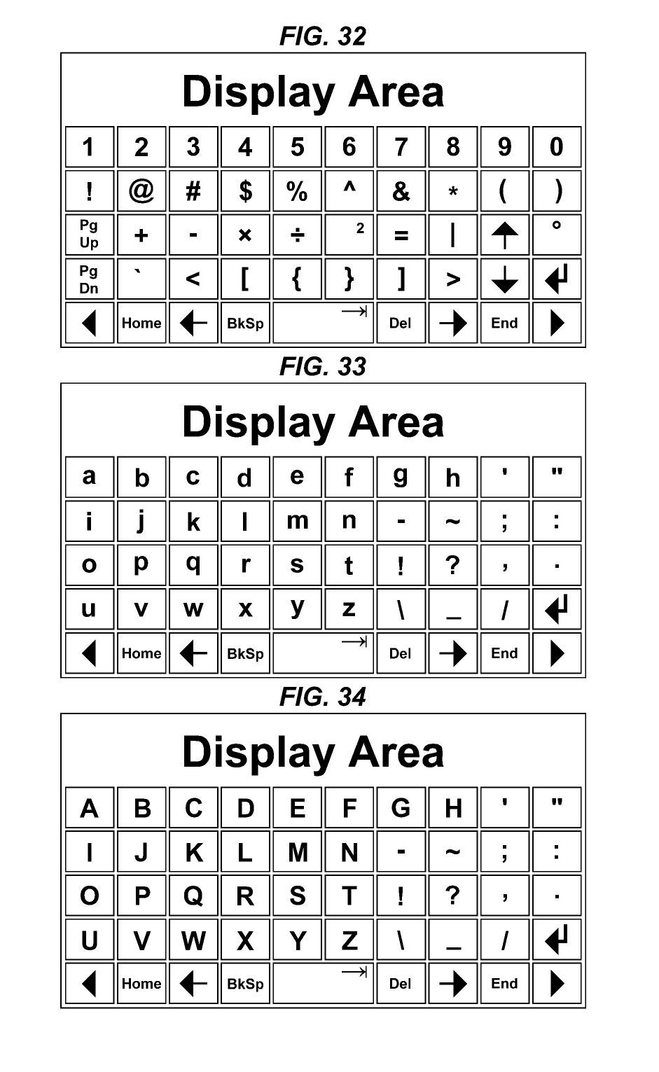

FIG. 32 is a top view of a first horizontal screen fifty sensor horizontal alphabetic keyboard display with ten columns and five rows wherein the left vertical column of capital vowel sensors are horizontally followed by an alphabetical sequence of capital consonant sensors and comprises punctuation sensors, symbol sensors, the enter sensor, and the backward, home, cursor left, backspace, space, delete, cursor right, end and forward sensors are on the bottom row. Activation of the forward sensor changes the screen to a second keyboard display and activation of the backward sensor changes the screen to a third keyboard display.

FIG. 33 is a top view of a second horizontal screen fifty sensor horizontal alphabetic keyboard display with ten columns and five rows wherein the left vertical column of vowel sensors are horizontally followed by an alphabetical sequence of consonant sensors and comprises punctuation sensors, symbol sensors, the enter sensor, and the backward, home, cursor left, backspace, space, delete, cursor right, end and forward sensors are on the bottom row. Activation of the forward sensor changes the screen to a third keyboard display and activation of the backward sensor changes the screen to a first keyboard display.

FIG. 34 is a top view of a third horizontal screen fifty sensor horizontal alphabetic keyboard display with ten columns and five rows comprising number sensors, symbol sensors, containment sensors, mathematical function sensors, punctuation, function sensors, cursor up and down sensors, the enter sensor, and the backward, home, cursor left, backspace, space, delete, cursor right, end and forward sensors are on the bottom row. Activation of the forward sensor changes the screen to a first keyboard display and activation of the backward sensor changes the screen to a second keyboard display. A fourth horizontal screen fifty sensor horizontal alphabetic keyboard display can be added to increase the data characters and functions.

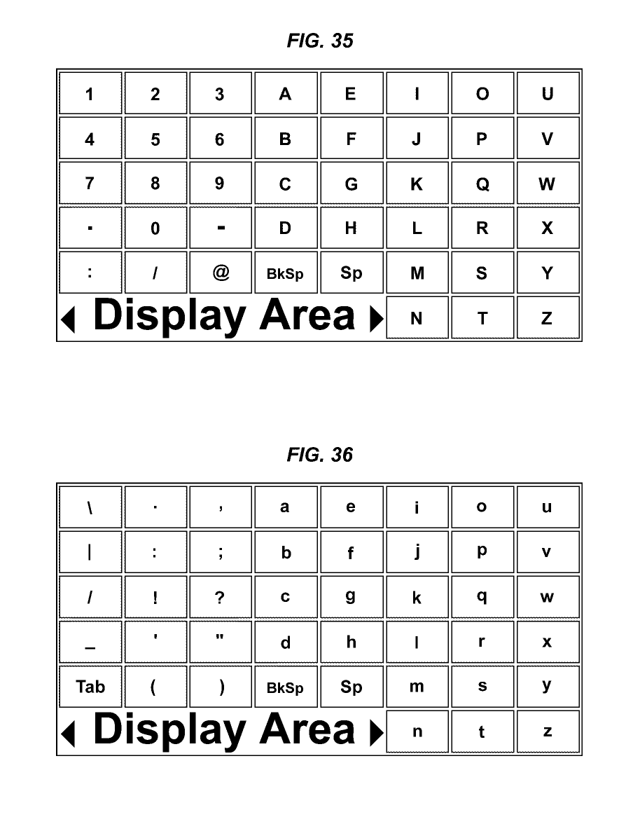

FIG. 35 is a top view of a first horizontal screen forty-two sensor/forty-eight sensor zone vertical alphabetic keyboard display with eight columns and six rows wherein the top horizontal row of capital vowel sensors are vertically followed by an alphabetical sequence of capital consonant sensors and comprises a numeric phone keypad sensor arrangement where the asterisk and pound sign are replaced with a dot and a dash, punctuation sensors, symbol sensors, backspace and space sensor, and the backward and forward sensors are in the bottom display area. Activation of the forward sensor changes the screen to a second keyboard display and activation of the backward sensor changes the screen to a third keyboard display (not shown). Using the preferred embodiment shown in FIG. 35 as a GPS user interface allows the user to input the town, zip code, street or numeric address using one display, and as a user interface for web access for entering web addresses or email addresses using the same display.

FIG. 36 is a top view of a second horizontal screen forty-two sensor/forty-eight sensor zone vertical alphabetic keyboard display with eight columns and six rows wherein the top horizontal row of vowel sensors are vertically followed by an alphabetical sequence of consonant sensors and comprises punctuation sensors, symbol sensors, containment sensors, the tab sensor, backspace and space sensor, and the backward and forward sensors are in the bottom display area. Activation of the forward sensor changes the screen to a first keyboard display or produces the enter function and activation of the backward sensor changes the screen to a first keyboard display. A third and fourth horizontal screen forty-eight sensor vertical alphabetic keyboard display can be added to increase the data characters and functions.

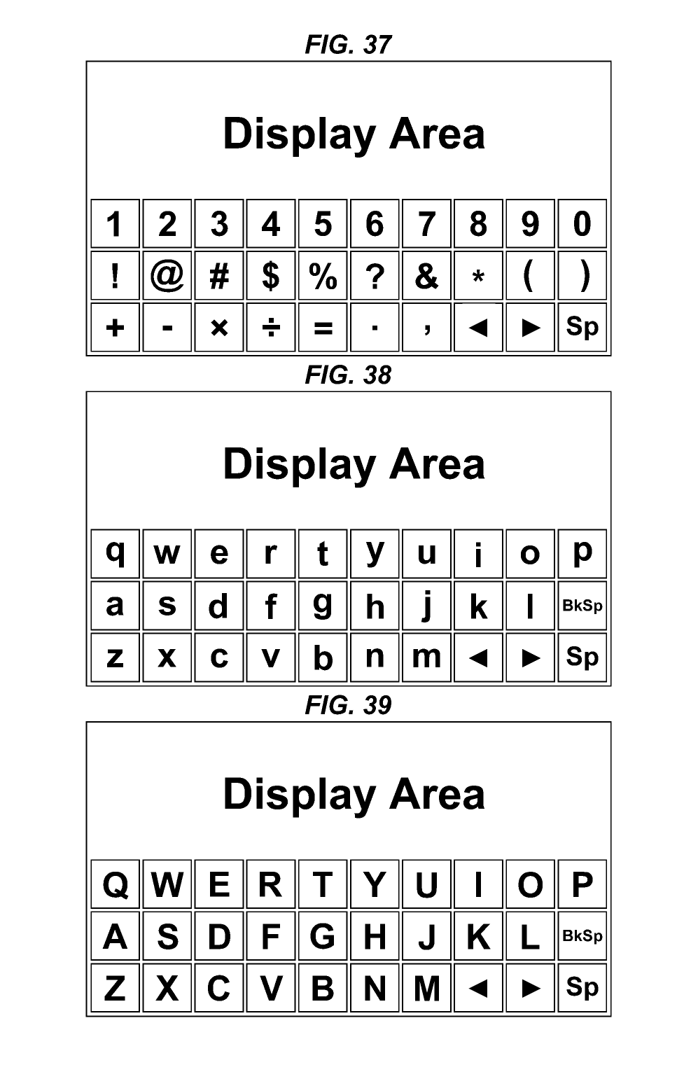

FIG. 37 is a top view of a first horizontal screen thirty sensor QWERTY keyboard display with ten columns and three rows and comprises sensors with capital letters of an alphabet, the backward and forward sensors, backspace and space sensors. Activation of the forward sensor changes the screen to a second keyboard display and activation of the backward sensor changes the screen to a third keyboard display.

FIG. 38 is a top view of a second horizontal screen thirty sensor QWERTY keyboard display with ten columns and three rows and comprises sensors with letters of an alphabet, the backward and forward sensors, backspace and space sensors. Activation of the forward sensor changes the screen to a third keyboard display and activation of the backward sensor changes the screen to a first keyboard display.

FIG. 39 is a top view of a third horizontal screen thirty sensor QWERTY keyboard display with ten columns and three rows comprising number sensors, punctuation sensors, symbol sensors, mathematical function sensors, containment sensors, the backward and forward sensors, backspace and space sensors. Activation of the forward sensor changes the screen to a first keyboard display and activation of the backward sensor changes the screen to a second keyboard display. A fourth horizontal screen thirty sensor keyboard display can be added to increase the data characters and functions.

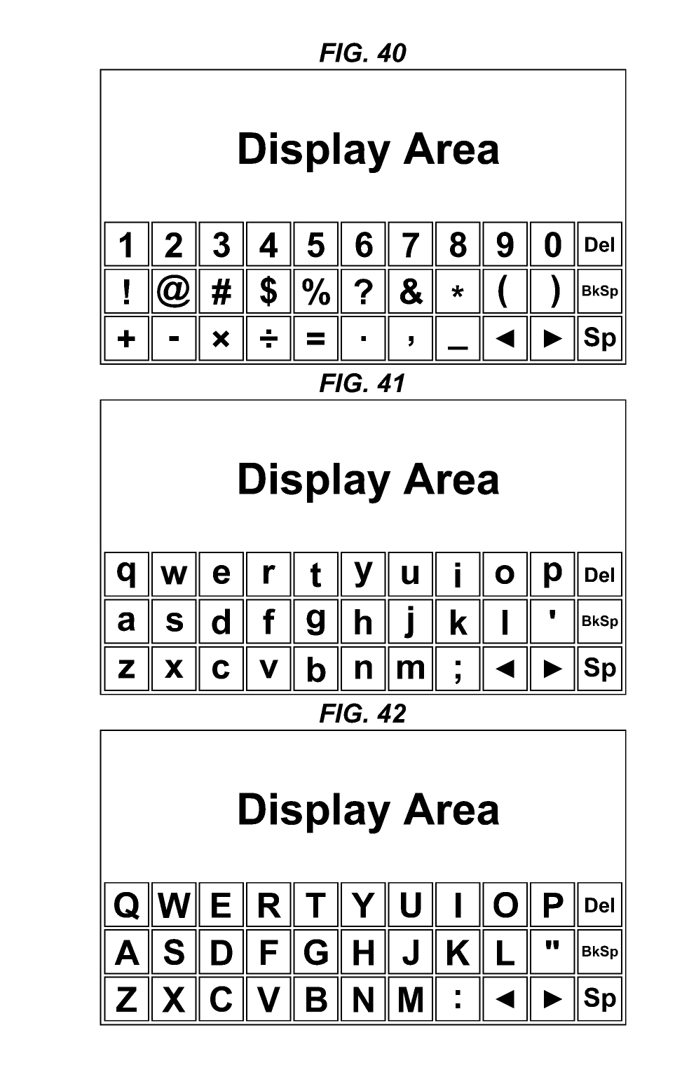

FIG. 40 is a top view of a first horizontal screen thirty-three sensor QWERTY keyboard display with eleven columns and three rows and comprises sensors with capital letters of an alphabet, punctuation sensors, the backward and forward sensors, backspace, space and delete sensors. Activation of the forward sensor changes the screen to a second keyboard display and activation of the backward sensor changes the screen to a third keyboard display.

FIG. 41 is a top view of a second horizontal screen thirty-three sensor QWERTY keyboard display with eleven columns and three rows and comprises sensors with letters of an alphabet, punctuation sensors, the backward and forward sensors, backspace, space and delete sensors. Activation of the forward sensor changes the screen to a third keyboard display and activation of the backward sensor changes the screen to a first keyboard display.

FIG. 42 is a top view of a third horizontal screen thirty-three sensor QWERTY keyboard display with eleven columns and three rows comprising number sensors, punctuation sensors, symbol sensors, mathematical function sensors, containment sensors, the backward and forward sensors, backspace, space and delete sensors. Activation of the forward sensor changes the screen to a first keyboard display and activation of the backward sensor changes the screen to a second keyboard display. A fourth horizontal screen thirty-three sensor keyboard display can be added to increase the data characters and functions.

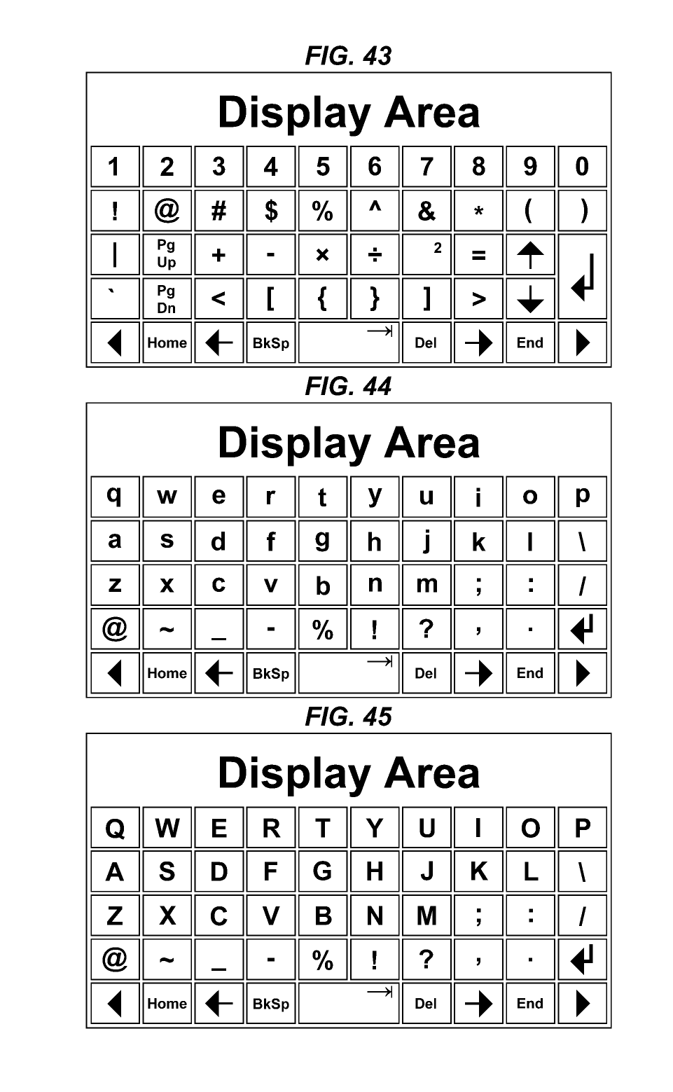

FIG. 43 is a top view of a first horizontal screen fifty sensor QWERTY keyboard display with ten columns and five rows comprising capital letters of an alphabet sensors, punctuation sensors, symbol sensors, the enter sensor, and the backward, home, cursor left, backspace, space, delete, cursor right, end and forward sensors are on the bottom row. Activation of the forward sensor changes the screen to a second keyboard display and activation of the backward sensor changes the screen to a third keyboard display.

FIG. 44 is a top view of a second horizontal screen fifty sensor QWERTY keyboard display with ten columns and five rows comprising letters of an alphabet sensors, punctuation sensors, symbol sensors, the enter sensor, and the backward, home, cursor left, backspace, space, delete, cursor right, end and forward sensors are on the bottom row. Activation of the forward sensor changes the screen to a third keyboard display and activation of the backward sensor changes the screen to a first keyboard display.

FIG. 45 is a top view of a third horizontal screen fifty sensor QWERTY keyboard display with ten columns and five rows comprising number sensors, symbol sensors, containment sensors, mathematical function sensors, punctuation, function sensors, cursor up and down sensors, the enter sensor, and the backward, home, cursor left, backspace, space, delete, cursor right, end and forward sensors are on the bottom row. Activation of the forward sensor changes the screen to a first keyboard display and activation of the backward sensor changes the screen to a second keyboard display. A fourth horizontal screen fifty sensor QWERTY keyboard display can be added to increase the data characters and functions.

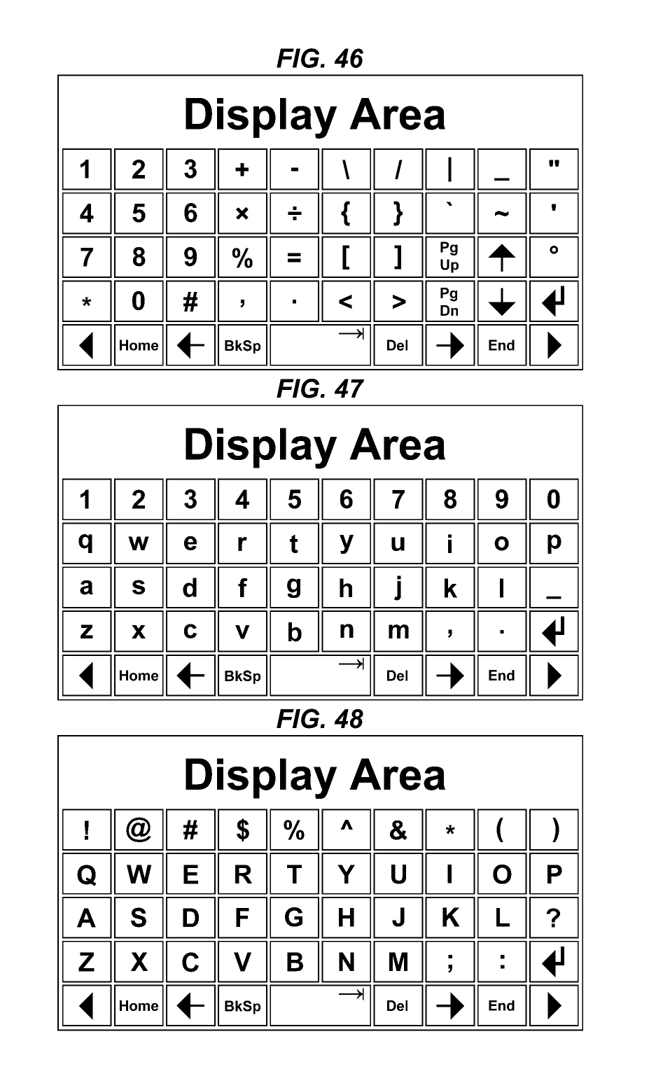

FIG. 46 is a top view of a first horizontal screen fifty sensor QWERTY keyboard display with ten columns and five rows comprising capital letters of an alphabet sensors, punctuation sensors, symbol sensors, containment sensors, the enter sensor, and the backward, home, cursor left, backspace, space, delete, cursor right, end and forward sensors are on the bottom row. Activation of the forward sensor changes the screen to a second keyboard display and activation of the backward sensor changes the screen to a third keyboard display.

FIG. 47 is a top view of a second horizontal screen fifty sensor QWERTY keyboard display with ten columns and five rows comprising letters of an alphabet sensors, number sensors, punctuation sensors, symbol sensors, the enter sensor, and the backward, home, cursor left, backspace, space, delete, cursor right, end and forward sensors are on the bottom row. Activation of the forward sensor changes the screen to a third keyboard display and activation of the backward sensor changes the screen to a first keyboard display.

FIG. 48 is a top view of a third horizontal screen fifty sensor QWERTY keyboard display with ten columns and five rows comprising a numeric phone keypad sensor arrangement, symbol sensors, containment sensors, mathematical function sensors, punctuation, function sensors, cursor up and down sensors, the enter sensor, and the backward, home, cursor left, backspace, space, delete, cursor right, end and forward sensors are on the bottom row. Activation of the forward sensor changes the screen to a first keyboard display and activation of the backward sensor changes the screen to a second keyboard display. A fourth horizontal screen fifty sensor QWERTY keyboard display can be added to increase the data characters and functions.

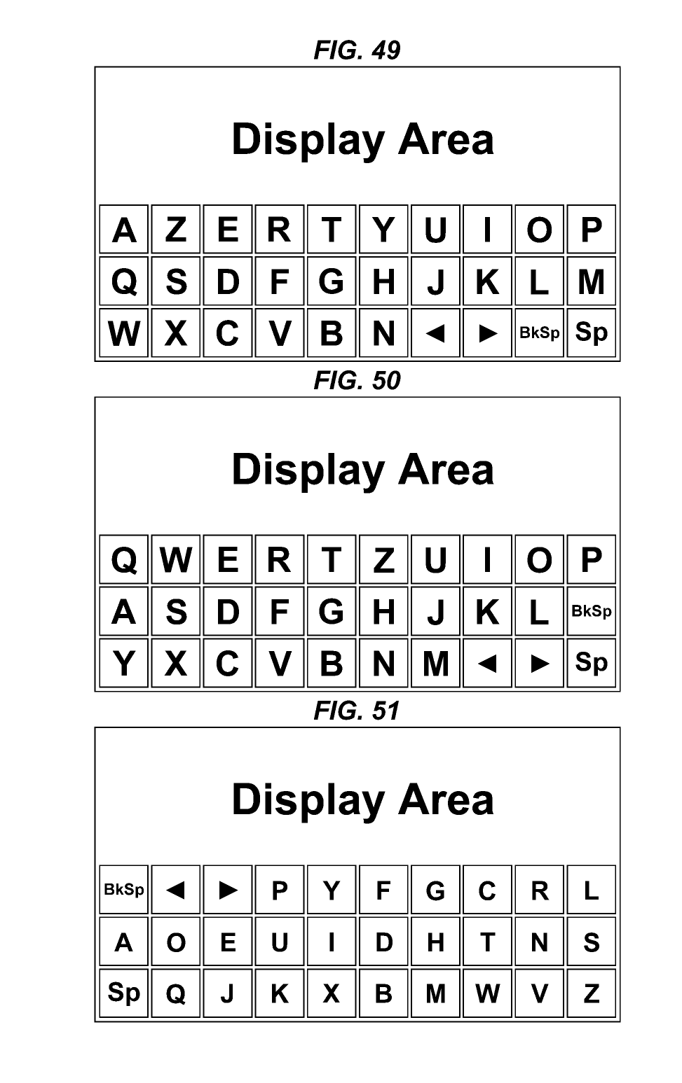

FIG. 49 is a top view of a first horizontal screen thirty sensor Dvorak keyboard display with ten columns and three rows and comprises sensors with capital letters of an alphabet, the backward and forward sensors, backspace and space sensors. Activation of the forward sensor changes the screen to a second keyboard display and activation of the backward sensor changes the screen to a third or fourth thirty sensor keyboard display.

FIG. 50 is a top view of a first horizontal screen thirty sensor QWERTZ keyboard display with ten columns and three rows and comprises sensors with capital letters of an alphabet, the backward and forward sensors, backspace and space sensors. Activation of the forward sensor changes the screen to a second keyboard display and activation of the backward sensor changes the screen to a third or fourth thirty sensor keyboard display.

FIG. 51 is a top view of a first horizontal screen thirty sensor AZERTY keyboard display with ten columns and three rows and comprises sensors with capital letters of an alphabet, the backward and forward sensors, backspace and space sensors. Activation of the forward sensor changes the screen to a second keyboard display and activation of the backward sensor changes the screen to a third or fourth thirty sensor keyboard display.

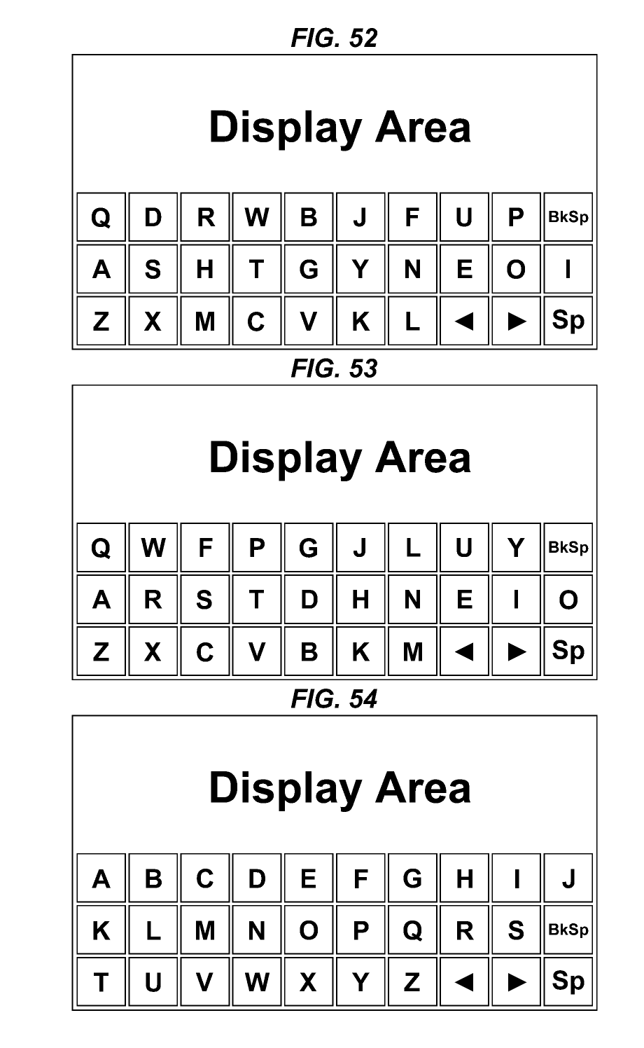

FIG. 52 is a top view of a first horizontal screen thirty sensor Alphabetic keyboard display with ten columns and three rows and comprises sensors with capital letters of an alphabet, the backward and forward sensors, backspace and space sensors. Activation of the forward sensor changes the screen to a second keyboard display and activation of the backward sensor changes the screen to a third or fourth thirty sensor keyboard display.

FIG. 53 is a top view of a first horizontal screen thirty sensor Colemak keyboard display with ten columns and three rows and comprises sensors with capital letters of an alphabet, the backward and forward sensors, backspace and space sensors. Activation of the forward sensor changes the screen to a second keyboard display and activation of the backward sensor changes the screen to a third or fourth thirty sensor keyboard display.

FIG. 54 is a top view of a first horizontal screen thirty sensor Workman keyboard display with ten columns and three rows and comprises sensors with capital letters of an alphabet, the backward and forward sensors, backspace and space sensors. Activation of the forward sensor changes the screen to a second keyboard display and activation of the backward sensor changes the screen to a third or fourth thirty sensor keyboard display.

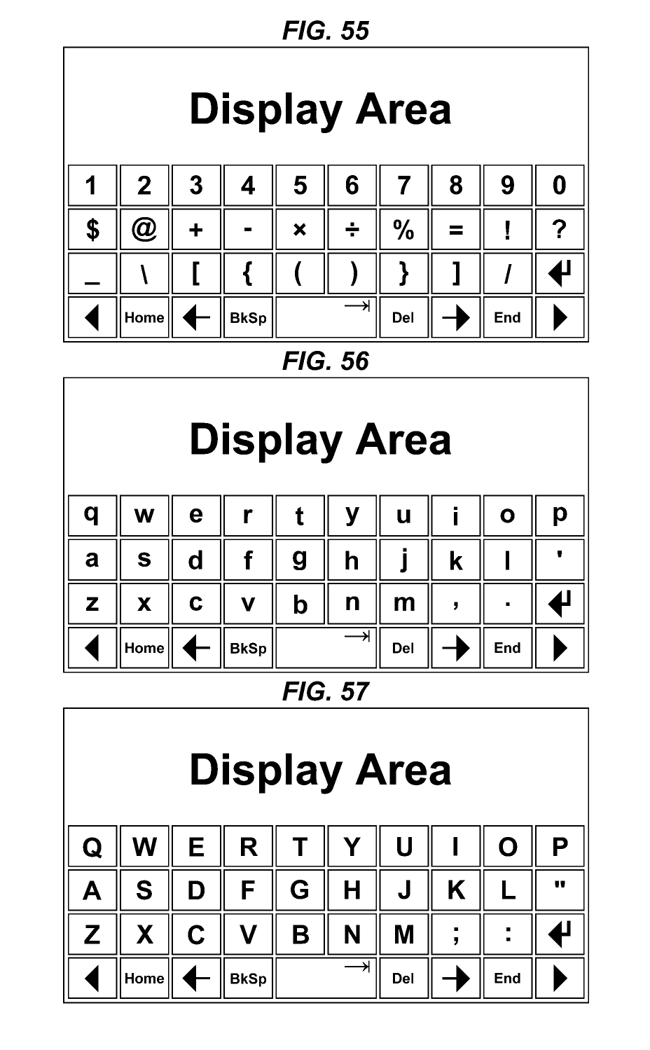

FIG. 55 is a top view of a first horizontal screen forty sensor QWERTY keyboard display with ten columns and four rows comprising capital letters of an alphabet sensors, punctuation sensors, the enter sensor, and the backward, home, cursor left, backspace, space, delete, cursor right, end and forward sensors are on the bottom row. Activation of the forward sensor changes the screen to a second keyboard display and activation of the backward sensor changes the screen to a third keyboard display.

FIG. 56 is a top view of a second horizontal screen forty sensor QWERTY keyboard display with ten columns and four rows comprising letters of an alphabet sensors, punctuation sensors, the enter sensor, and the backward, home, cursor left, backspace, space, delete, cursor right, end and forward sensors are on the bottom row. Activation of the forward sensor changes the screen to a third keyboard display and activation of the backward sensor changes the screen to a first keyboard display.

FIG. 57 is a top view of a third horizontal screen forty sensor QWERTY keyboard display with ten columns and four rows comprising number sensors, symbol sensors, containment sensors, mathematical function sensors, punctuation, the enter sensor, and the backward, home, cursor left, backspace, space, delete, cursor right, end and forward sensors are on the bottom row. Activation of the forward sensor changes the screen to a first keyboard display and activation of the backward sensor changes the screen to a second keyboard display. A fourth horizontal screen forty sensor QWERTY keyboard display can be added to increase the data characters and functions.

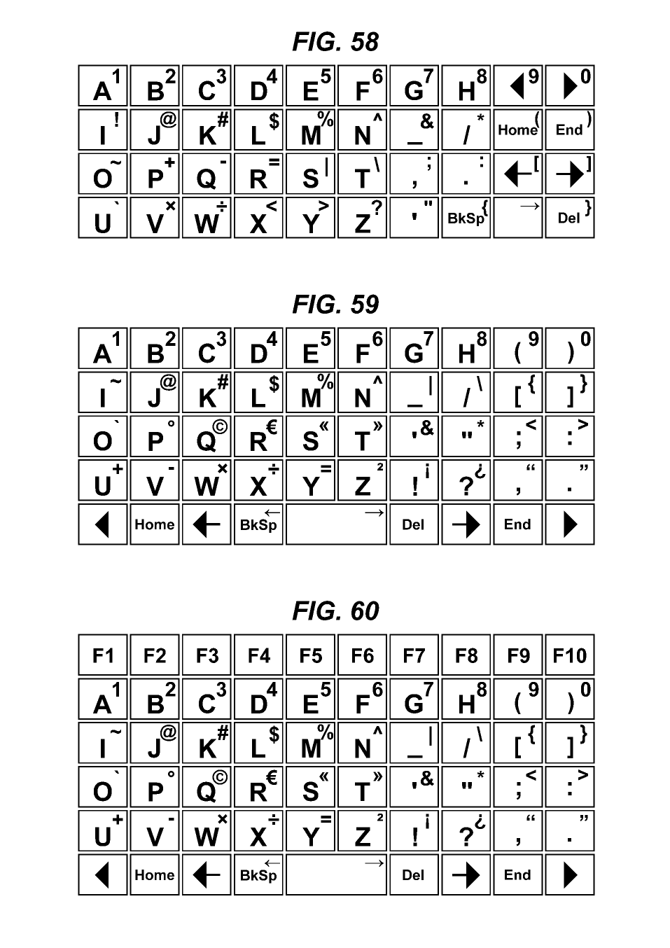

FIG. 58 is a top view of a horizontal sixty sensor alphabetic keyboard or display with ten columns and six rows wherein the left vertical row of vowels are horizontally followed by an alphabetical sequence of consonants comprising sensors or keys functioning as and labeled with, letters of an alphabet, numbers, punctuation, symbols, containment, and the backward, home, cursor left, backspace, space, delete, cursor right, end and forward function sensors are on the bottom row. Activation of the forward sensor produces the enter function and activation of the backward sensor one time produces the shift function or the simultaneous activation of the backward sensor combined with a secondary sensor produces the shift function, activation of the backward sensor two times produces the caps lock function, and activation of the backward sensor three times produces a secondary character lock function, where activation of any sensor other than the backward sensor produces the secondary character or function for that sensor, and successive secondary activation of the backward sensor returns the device to the normal/standard data entry mode.

FIG. 59 is a top view of a horizontal fifty sensor alphabetic keyboard or display with ten columns and five rows wherein the left vertical row of vowels are horizontally followed by an alphabetical sequence of consonants comprising sensors or keys functioning as and labeled with, letters of an alphabet, numbers, punctuation, symbols, containment, and the backward, home, cursor left, backspace, space, delete, cursor right, end and forward function sensors are on the bottom row. Activation of the forward sensor produces the enter function and activation of the backward sensor one time produces the shift function or the simultaneous activation of the backward sensor combined with a secondary sensor produces the shift function, activation of the backward sensor two times produces the caps lock function, and activation of the backward sensor three times produces a secondary character lock function, where activation of any sensor other than the backward sensor produces the secondary character or function for that sensor, and successive secondary activation of the backward sensor returns the device to the normal/standard data entry mode.

FIG. 60 is a top view of a first horizontal screen forty sensor alphabetic keyboard or display with ten columns and five rows wherein the left vertical row of vowels are horizontally followed by an alphabetical sequence of consonants comprising sensors or keys functioning as and labeled with, letters of an alphabet, punctuation, symbols, and the backward, home, cursor left, backspace, space, delete, cursor right, end and forward function sensors are on the bottom row. Activation of the forward sensor changes the screen to a second keyboard display and activation of the backward sensor changes the screen to a third keyboard display. Activation of the forward sensor produces the enter function and activation of the backward sensor one time produces the shift function, two times produces the caps lock function, and three times produces a secondary character lock function, where activation of any sensor other than the backward sensor produces the secondary character or function for that sensor, and successive secondary activation of the backward sensor returns the device to the normal/standard data entry mode.

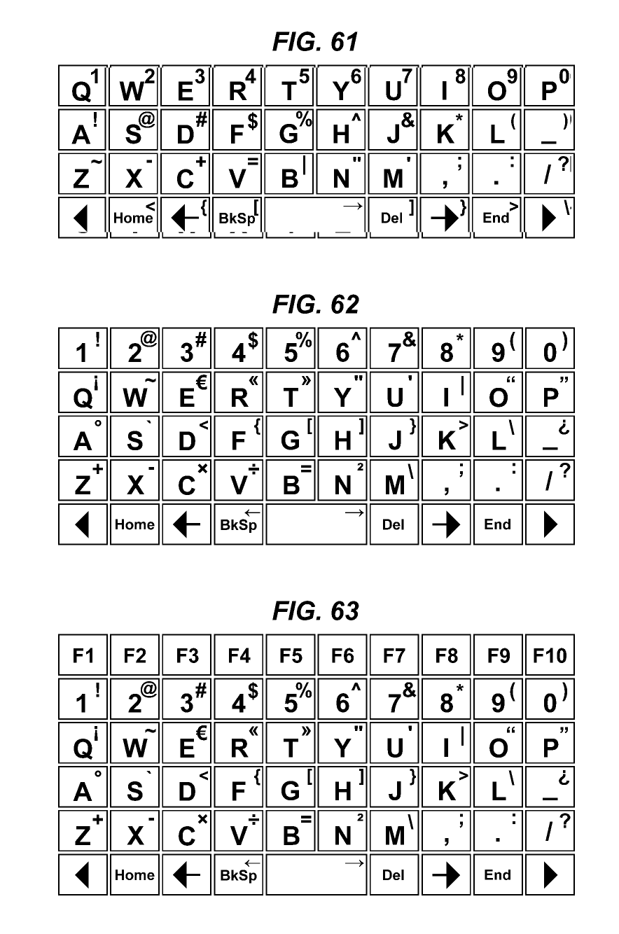

FIG. 61 is a top view of a horizontal sixty sensor QWERTY keyboard or display with ten columns and six rows comprising sensors or keys functioning as and labeled with, letters of an alphabet, numbers, punctuation, symbols, containment, and the backward, home, cursor left, backspace, space, delete, cursor right, end and forward function sensors are on the bottom row. Activation of the forward sensor produces the enter function and activation of the backward sensor one time produces the shift function or the simultaneous activation of the backward sensor combined with a secondary sensor produces the shift function, activation of the backward sensor two times produces the caps lock function, and activation of the backward sensor three times produces a secondary character lock function, where activation of any sensor other than the backward sensor produces the secondary character or function for that sensor, and successive secondary activation of the backward sensor returns the device to the normal/standard data entry mode.

FIG. 62 is a top view of a horizontal fifty sensor QWERTY keyboard or display with ten columns and five rows comprising sensors or keys functioning as and labeled with, letters of an alphabet, numbers, punctuation, symbols, containment, and the backward, home, cursor left, backspace, space, delete, cursor right, end and forward function sensors are on the bottom row. Activation of the forward sensor produces the enter function and activation of the backward sensor one time produces the shift function or the simultaneous activation of the backward sensor combined with a secondary sensor produces the shift function, activation of the backward sensor two times produces the caps lock function, and activation of the backward sensor three times produces a secondary character lock function, where activation of any sensor other than the backward sensor produces the secondary character or function for that sensor, and successive secondary activation of the backward sensor returns the device to the normal/standard data entry mode.

FIG. 63 is a top view of a first horizontal screen forty sensor QWERTY keyboard display with ten columns and four rows comprising sensors or keys functioning as and labeled with, letters of an alphabet, punctuation, symbols, and the backward, home, cursor left, backspace, space, delete, cursor right, end and forward function sensors are on the bottom row. Activation of the forward sensor changes the screen to a second keyboard display and activation of the backward sensor changes the screen to a third keyboard display. Activation of the forward sensor produces the enter function and activation of the backward sensor one time produces the shift function, two times produces the caps lock function, and three times produces a secondary character lock function, where activation of any sensor other than the backward sensor produces the secondary character or function for that sensor, and successive secondary activation of the backward sensor returns the device to the normal/standard data entry mode.

The user interfaces shown in FIGS. 58-60 (Vowel) and FIGS. 61-63 (QWERTY), are shown where the user interface display does not change (such as a keypad or button keyboard embodiment) and uses the [ [symbol] ] key/sensor to produce the dead key “Shift” function or “Secondary” function mode when activated one time prior to the activation of a sensor other than the [ [symbol] ] key/sensor. An example of a “Secondary” function mode would be the “Back Tab” [|←] or [←] function (found on the [BkSp]/“Backspace” sensor) and the “Tab” [→|] or [→] function (found on the [Sp]/“Space” sensor) shown in FIGS. 58-59 (Vowel) and FIGS. 61-62 (QWERTY) embodiments. The [ [symbol] ] key/sensor produces the dead key “Caps Lock” function when activated two times prior to the activation of a sensor other than the [ [symbol] ] key/sensor and sequential activation of the [ [symbol] ] key/sensor after producing data character(s) exits the “Caps Lock” function and returns to the standard data entry mode. The [ [symbol] ] key/sensor produces the dead key “Symbol Lock” or “Calculator Lock” function when activated three times prior to the activation of a sensor other than the [ [symbol] ] key/sensor and sequential activation of the [ [symbol] ] key/sensor after producing data character(s) exits the “Symbol Lock” or “Calculator Lock” function and returns to the standard data entry mode. The [ [symbol] ] key/sensor produces the “Enter” [ [symbol] ] function.

Activating the [ [symbol] ] key/sensor simultaneously with the [I] sensor produces the “Italics” function; [B] sensor produces the “Bold” function; [U] sensor produces the “Underline” function; [A] sensor produces the “All” function; [S] sensor produces the “Save” function; [F] sensor produces the “Find” function; [G] sensor produces the “Go To” function; [H] sensor produces the “Replace” function; [K] sensor produces the “Hyperlink” function (although [W] is more mnemonic); [Z] sensor produces the “Undo” function; [Y] sensor produces the “Redo” function (although [R] is more mnemonic); [X] sensor produces the “Cut” function; [C] sensor produces the “Copy” function; [V] sensor produces the “Paste” function; [N] sensor produces the “New” function; [O] sensor produces the “Open” function; [P] sensor produces the “Print” function; [W] sensor produces the “Symbol” function; [F1] or [F3] sensor produces the “Reveal Codes” function; [F4] sensor produces the “Close”/“Exit” function; [ [symbol] ] sensor produces the “New Page” function; etc. The [ [symbol] ] key/sensor produces the dead key “Alt” function when activated one time prior to the activation of a [F1]-[F10] sensor. “Alt” function then [F1] can produce the [F11] function. “Alt” function then [F2] can produce the [F12] function.

The FIG. 35 embodiment, along with all the previously disclosed first embodiment user interface keyboard arrangements can produce a capital letter at the beginning of a sentence, and then lower case letters until the end of a sentence punctuation mark (. ! ?) is entered. Activating the dead [ [symbol] ] key/sensor would allow a user to capitalize a word in the middle of a sentence. Activating the dead [ [symbol] ] key/sensor twice would allow a user to produce the “Caps Lock” function. This method of data entry would change the second embodiment user interface keyboard arrangements to exclude the lower case data characters and include more punctuation, symbols, functions, etc. The present patent application already has 63 figure drawings, and to show preferred embodiments of the previously disclosed changes to the user interfaces and some of the following other keyboard user interfaces would produce a lengthy patent application.

Other keyboards which can benefit from any of the previously disclosed keyboard arrangements, key/sensor labeling and features include the Alphabetic keyboard, Dvorak keyboard, Einbinder keyboard, Colemak keyboard, Workman keyboard, United Kingdom (ISO) keyboard, Canadian Multilingual keyboard, QWERTZ keyboard, AZERTY keyboard, QZERTY keyboard, International keyboard, ACNOR keyboard, Arabic keyboard, Armenian keyboard, Bulgarian keyboard, Chinese keyboard, Cyrillic keyboard, Devanagari InScript bilingual keyboard, Dzongkha keyboard, Finnish multilingual keyboard, Greek keyboard, Hebrew keyboard, Japanese keyboard, JCUKEN keyboard, Khmer keyboard, Korean keyboard, Norwegian keyboard, Persian Keyboard, Polish keyboard, Russian keyboard, Sanskrit keyboard, That keyboard, Tibetan keyboard, Turkish keyboard, Ukrainian keyboard, etc.

Although the previously disclosed keyboards are shown using only twenty-six letters of the English alphabet, foreign language vowels and consonants can easily be substituted and produced. Activating the settings sensor on a device allows the user to set the keyboard to a preferred language keyboard data character set or substitute any data character on any user interface for any desired application.

Alternatively, another embodiment for producing a data character set exceeding the twenty-six letters found in the English alphabet includes; activating the [n] sensor and then sliding the finger tip to the left, right, up, down or diagonally, or depressing the sensor for a preset duration of time produces the “ñ” (n with a tilde). Activating the [c] sensor and then sliding the finger tip to the left, right, up, down or diagonally, or depressing the sensor for a preset duration of time produces the “ç” cedilla. Activating the [g] sensor and then sliding the finger tip to the left, right, up, down or diagonally, or depressing the sensor for a preset duration of time produces the dotted ġ of Maltese. Activating the [j] sensor and then sliding the finger tip to the left, right, up, down or diagonally, or depressing the sensor for a preset duration of time produces the circumflexed j of Esperanto. Activating the [B] sensor and then sliding the finger tip to the left, right, up, down or diagonally, or depressing the sensor for a preset duration of time produces the B. Activating the [“] sensor and then sliding the finger tip to the left, right, up, down or diagonally, or depressing the sensor for a preset duration of time produces the French quotation marks or guillemets << >>. In languages such as Lithuanian, etc. with a multitude of accented vowels, activating an unaccented vowel then sliding the finger tip to the left, right, up, down or diagonally, or depressing the sensor for a preset duration of time will bring up a temporary screen that shows that vowel's variations with an acute accent, grave accent, dieresis accent, circumflex accent, tilde accent, etc. (á à ä ã â é è ë ê í ì ï î ó ò ö õ ô ú ù ü û etc.) After the accented vowel is activated, the screen returns to the prior keyboard display. Inclusion of a dead key, a key that is pressed and released before the other key, can also be included as an alternative keyboard arrangement and control means as previously disclosed. Activating any key or sensor for a preprogrammed duration of time will also produce a secondary character or function.

Another feature of the invention includes touching a sensor on the top row of the keyboard or the screen and sliding the finger downward to decrease the height of the keyboard display. A secondary sensor can also produce this function.

Another feature involves touching a sensor on the top row of the display and sliding the finger downward diagonally to a left or right bottom corner to minimize the keyboard display. A secondary sensor can also produce this function. Activating an icon or key in the left or right bottom corner or sliding a finger tip diagonally upward across the display maximizes the keyboard display.

Another feature involves activating the backward [ [symbol] ] (previous) sensor or key to produce the tab shift function where activation of the [Space] function key or sensor or the [→] or [→|] tab function key or sensor one or more times produces the tab function one or more times and activation of the [BkSp] function key or sensor or the [←] or [|←] back tab function key or sensor one or more times produces the back tab function one or more times.

These and other features of the present invention will be more fully understood by referencing the drawings.

In summary, the keyboard and touchscreen keyboard invention, according to the preferred embodiments and alternative preferred embodiments of the invention, are easier, faster and more efficient to use than present prior art keyboards and preferably use an “ortho-linear” keyboard arrangement, also known as a “matrix” or “grid” keyboard arrangement. The claims are directed towards the vowel keyboard arrangement; the backward and forward function keys/sensors for changing keyboard displays, keyboard functions or data and function produced by each key/sensor; and the backward, home, cursor left, backspace, space, delete, cursor right, end and forward sensors are on the bottom row, and the use of the forward or next sensor to produce the enter function and the use of the backwards or previous sensor to produce the shift function.

### Advantages of the Present Invention

The present invention has provided the advantage of a data entry user interface for entering data using a first set of data character sensors, a space sensor, a backspace sensor, a forward or next sensor, wherein activation of said forward or next sensor produces a second set of data character sensors, and a backwards or previous sensor, wherein activation of said backwards or previous sensor produces a third set of data character sensors which reduces the amount of keys or sensors required for a data entry user interface.

The present invention has provided the advantage of a data entry user interface for entering data using a first set of data character sensors, a backwards or previous function sensor located on the left of said space bar sensor, a home function sensor located on the left of said space bar sensor, a cursor left function sensor located on the left of said space bar sensor, a backspace function sensor located on the left of said space bar sensor, a delete function sensor located on the right of said space bar sensor, a cursor right function sensor located on the right of said space bar sensor, an end function sensor located on the right of said space bar sensor, and a forward or next function sensor located on the right of said space bar sensor which improves the efficiency of a data entry user interface for entering and editing data.

The present invention has provided the advantage of a data entry user interface for entering data using a first set of data character sensors, a space sensor, a backspace sensor, a forward or next sensor, wherein activation of said forward or next sensor produces the enter function, and a backwards or previous sensor, wherein activation of said backwards or previous sensor produces the shift function which improves the efficiency of a data entry user interface for entering and editing data and reduces the amount of keys or sensors required for a data entry user interface.

While the present invention disclosed has been described with reference to the preferred embodiments thereof, a latitude of modification, change, repositioning of elements, relocation of elements, and substitution is intended in the foregoing disclosure and drawings, and in some instances, some features of the invention will be employed without a corresponding use of the invention's other features. Accordingly, it will be appreciated by those having an ordinary skill in the art that the above description is only illustrative of specific embodiments and examples of the invention. Various modifications and variations can be made to the present invention, and it is appropriate that the description and appended claims are construed broadly and in a manner consistent with the true spirit and scope of the invention herein, without departing from the spirit and scope of the invention as a whole. The present embodiments are to be considered in all respects as illustrative and not restrictive, and all changes or modifications coming within the meanings and equivalency ranges of the appended claims are intended to be embraced therein. The accompanying claims are intended to cover such modifications, as they would fall within the true scope and spirit of the present invention.

1. A data entry user interface for entering data comprising:
a first set of data character sensors;
a space sensor;
a backspace sensor;
a forward or next sensor, wherein activation of said forward or next sensor produces a second set of data character sensors; and
a backwards or previous sensor, wherein activation of said backwards or previous sensor produces a third set of data character sensors.

2. A data entry user interface for entering data, in accordance with claim 1, wherein activation of said backwards or previous sensor produces a fourth set of data character sensors.

3. A data entry user interface for entering data, in accordance with claim 1, wherein activation of said backwards or previous sensor produces a capitalized second set of data character sensors.

4. A data entry user interface for entering data, in accordance with claim 1, wherein activation of said backwards or previous sensor twice produces a capitalized second set of data character sensors continuously.

5. A data entry user interface for entering data, in accordance with claim 1, wherein activation of said backwards or previous sensor three times produces a third set of data character sensors.

6. A data entry user interface for entering data, in accordance with claim 5, wherein activation of said forward or next sensor produces said first set of data character sensors.

7. A data entry user interface for entering data, in accordance with claim 1, wherein said data entry user interface display is overlaid with a columns and rows of touch sensor zones.

8. A data entry user interface for entering data, in accordance with claim 1, wherein said first set of data character sensors comprises an alphabetical sequence of sensors wherein each vowel sensor is followed by an alphabetical sequence of consonant sensors.

9. A data entry user interface for entering data, in accordance with claim 8, wherein said first set of data character sensors comprises at least four rows of sensors wherein said vowel sensors are horizontally followed by said alphabetical sequence of consonant sensors.

10. A data entry user interface for entering data, in accordance with claim 8, wherein said first set of data character sensors comprises at least four columns of sensors wherein said vowel sensors are vertically followed by said alphabetical sequence of consonant sensors.

11. A data entry user interface for entering data, in accordance with claim 1, wherein said backwards or previous function sensor located on the left of said space bar sensor; and
said forward or next function sensor located on the right of said space bar sensor.

12. A data entry user interface for entering data, in accordance with claim 1, wherein said backwards or previous function sensor located on the left of said space bar sensor;
a backspace function sensor located on the left of said space bar sensor;
a delete function sensor located on the right of said space bar sensor; and
said forward or next function sensor located on the right of said space bar sensor.

13. A data entry user interface for entering data, in accordance with claim 1, wherein a home function sensor located on the left of said space bar sensor;
a cursor left function sensor located on the left of said space bar sensor;
a backspace function sensor located on the left of said space bar sensor;
a delete function sensor located on the right of said space bar sensor;
a cursor right function sensor located on the right of said space bar sensor; and
an end function sensor located on the right of said space bar sensor.

14. A data entry user interface for entering data, in accordance with claim 1, wherein said backwards or previous function sensor located on the left of said space bar sensor;
a home function sensor located on the left of said space bar sensor;
a cursor left function sensor located on the left of said space bar sensor;
a backspace function sensor located on the left of said space bar sensor;
a delete function sensor located on the right of said space bar sensor;
a cursor right function sensor located on the right of said space bar sensor;
an end function sensor located on the right of said space bar sensor; and
said forward or next function sensor located on the right of said space bar sensor.

15. A data entry user interface for entering data comprising:
a first set of data character sensors;
a backwards or previous function sensor located on the left of said space bar sensor;
a home function sensor located on the left of said space bar sensor;
a cursor left function sensor located on the left of said space bar sensor;
a backspace function sensor located on the left of said space bar sensor;
a delete function sensor located on the right of said space bar sensor;
a cursor right function sensor located on the right of said space bar sensor;
an end function sensor located on the right of said space bar sensor; and
a forward or next function sensor located on the right of said space bar sensor.

16. A data entry user interface for entering data, in accordance with claim 15, wherein activation of said forward or next function sensor produces the enter function.

17. A data entry user interface for entering data, in accordance with claim 15, wherein activation of said backwards or previous function sensor one time produces the shift function

18. A data entry user interface for entering data, in accordance with claim 15, wherein activation of said backwards or previous function sensor two times produces the caps lock function, where activation of any sensor other than said backwards or previous function sensor produces the caps lock function for that sensor, and successive secondary activation of said backwards or previous function sensor returns said user interface to a standard data entry mode.

19. A data entry user interface for entering data, in accordance with claim 15, wherein activation of said backwards or previous function sensor three times produces a secondary character lock function, where activation of any sensor other than said backwards or previous function sensor produces the secondary character or function for that sensor, and successive secondary activation of said backwards or previous function sensor returns said user interface to a standard data entry mode.

20. A data entry user interface for entering data comprising:
a first set of data character sensors;
a space sensor;
a backspace sensor;
a forward or next sensor, wherein activation of said forward or next sensor produces the enter function; and
a backwards or previous sensor, wherein activation of said backwards or previous sensor produces the shift function.
